(19) United States
(12) Patent Application Publication
(10) Pub. No.: US 2023/0244938 A1
(43) Pub. Date: Aug. 3, 2023

(54) Using Chains of Thought to Prompt Machine-Learned Models Pre-Trained on Diversified Objectives

(71) Applicant: Google LLC, Mountain View, CA (US)

(72) Inventors: Jason Weng Wei, Mountain View, CA (US); Dengyong Zhou, Redmond, WA (US); Xuezhi Wang, New York, NY (US); Dale Eric Schuurmans, Edmonton (CA); Quoc V. Le, Sunnyvale, CA (US); Maarten Paul Bosma, Cupertino, CA (US); Ed Huai-Hsin Chi, Palo Alto, CA (US); Olivier Jean Andrè Bousquet, Zürich (CH); Le Hou, South Setauket, NY (US); Charles Aloysius Sutton, Santa Clara, CA (US); Nathanael Martin Schärli, Pittsburgh, PA (US); Nathan Kemp Sekiguchi Scales, Baar (CH); Augustus Quadrozzi Odena, San Francisco, CA (US); Sharan Ajit Narang, San Francisco, CA (US); Guy Gur-Ari Krakover, Palo Alto, CA (US); Aakanksha Chowdhery, Santa Clara, CA (US); David Martin Dohan, San Francisco, CA (US); Aitor Lewkowycz, San Jose, CA (US); Henryk Michalewski, Oxfordshire (GB); Jiageng Luan, San Francisco, CA (US); David J. Bieber, New York, NY (US); Jacob Austin, New York, NY (US); Anders Johan Andreassen, Princeton, NJ (US); Maxwell Isaac Nye, San Francisco, CA (US); Yi Tay, Singapore (SG); Mostafa Dehghani, Amsterdam (NL)

(21) Appl. No.: 18/160,776

(22) Filed: Jan. 27, 2023

Related U.S. Application Data
(60) Provisional application No. 63/305,910, filed on Feb. 2, 2022.
(60) Provisional application No. 63/348,637, filed on Jun. 3, 2022.

(51) Int. Cl. G06N 3/08

(52) U.S. Cl. CPC G06N 3/08

(57) ABSTRACT

An example method for pretraining a machine-learned model is provided. The example method includes obtaining a plurality of different combinations of configuration parameters of a pretraining objective framework. The example method includes generating, using the pretraining objective framework, a plurality of corrupted training examples from one or more training examples, wherein the plurality of corrupted training examples are respectively generated according to the plurality of different combinations. The example method includes inputting the plurality of corrupted training examples into the machine-learned model, wherein the machine-learned model is configured to generate uncorrupted subportions corresponding to corrupted subportions of the corrupted training examples. The example method includes obtaining, from the machine-learned model, a plurality of outputs respectively generated by the machine-learned model based on the plurality of corrupted training examples. The example method includes updating one or more parameters of the machine-learned model based on an evaluation of the plurality of outputs.

### PRIORITY CLAIM

The present application claims priority to and the benefit of each of the following applications: U.S. Provisional Patent Application No. 63/305,910, filed Feb. 2, 2022; and U.S. Provisional Patent Application No. 63/348,637, filed Jun. 3, 2022. Each of the applications identified above is hereby incorporated by reference herein in its entirety.

### FIELD

The present disclosure relates generally to the control of machine-learned models. More particularly, the present disclosure relates to constructing prompting inputs for machine-learned models. The present disclosure also relates generally to improved objectives for pretraining machine-learned models to respond to such prompting inputs.

### BACKGROUND

The training of machine-learned models can be completed in stages. A model can be pre-trained for general release and, optionally, subsequently fine-tuned for specific tasks. Pre-training can include pursuit of unsupervised objectives across unlabeled training datasets, often followed by supervised learning on smaller, labeled datasets in the fine-tuning stage. In other cases, pre-trained models can be directly applied to a particular task without fine-tuning.

Once trained, machine-learned models can provide various functionality or perform various tasks. Trained models can be further instructed to perform particular tasks by providing inputs to the model with rich context that prompts the model to behave in a desired fashion.

### SUMMARY

Aspects and advantages of embodiments of the present disclosure will be set forth in part in the following description, or can be learned from the description, or can be learned through practice of the embodiments.

In one example aspect, example embodiments of the present disclosure provide for an example computer-implemented method for improved prompting of a machine-learned model. The example method includes obtaining, by a computing system including one or more processors, an instructive sequence descriptive of an instructive query, an instructive response, and an instructive trace of intermediate states from the instructive query to the instructive response. The example method includes inputting, by the computing system and to a machine-learned model, the instructive sequence and an operative query, wherein the machine-learned model is configured to process the operative query with attention over the instructive sequence. The example method includes generating, by the computing system, using the machine-learned model and responsive to the operative query, an operative response.

In one example aspect, example embodiments of the present disclosure provide for one or more example memory devices storing computer-readable instructions for improved prompting of a machine-learned model, the instructions executable to cause one or more processors to perform example operations. The example operations include obtaining an instructive sequence descriptive of an instructive query, an instructive response, and an instructive trace of intermediate states from the instructive query to the instructive response. The example operations include inputting, to a machine-learned model, the instructive sequence and an operative query, wherein the machine-learned model is configured to process the operative query with attention over the instructive sequence. The example operations include generating, using the machine-learned model, a plurality of operative responses. The example operations include determining a consistency metric based on a sample of the plurality of operative responses. The example operations include determining an operative response based on the consistency metric.

In one example aspect, example embodiments of the present disclosure provide for an example computing system for improved prompting of a machine-learned model. The example system includes one or more processors and one or more memory devices storing computer-readable instructions executable to cause the one or more processors to perform example operations. In the example system, the example operations include obtaining an instructive sequence descriptive of an instructive query, an instructive response, and an instructive trace of intermediate states from the instructive query to the instructive response. In the example system, the example operations include inputting, to a machine-learned model, the instructive sequence and an operative query, wherein the machine-learned model is configured to process the operative query with attention over the instructive sequence. In the example system, the example operations include generating, using the machine-learned model, a plurality of operative responses. In the example system, the example operations include determining a consistency metric based on a sample of the plurality of operative responses. In the example system, the example operations include determining an operative response based on the consistency metric.

Another example aspect of the present disclosure is directed to an example computer-implemented method for pretraining a machine-learned model with diversified objectives. The example method can include obtaining a plurality of different combinations of configuration parameters of a pretraining objective framework. The example method can include generating, using the pretraining objective framework, a plurality of corrupted training examples from one or more training examples. The plurality of corrupted training examples can be respectively generated according to the plurality of different combinations of configuration parameters. The example method can include inputting the plurality of corrupted training examples into the machine-learned model. The machine-learned model can be configured to generate uncorrupted subportions corresponding to corrupted subportions of the corrupted training examples. The example method can include obtaining, from the machine-learned model, a plurality of outputs respectively generated by the machine-learned model based on the plurality of corrupted training examples. The example method can include updating one or more parameters of the machine-learned model based on an evaluation of the plurality of outputs.

In another aspect, example embodiments of the present disclosure provide an example non-transitory, computer-readable medium storing instructions that are executable to cause one or more processors to perform example operations. The example operations can include obtaining a plurality of different combinations of configuration parameters of a pretraining objective framework. The example operations can include generating, using the pretraining objective framework, a plurality of corrupted training examples from one or more training examples. The plurality of corrupted training examples can be respectively generated according to the plurality of different combinations of configuration parameters. The example operations can include inputting the plurality of corrupted training examples into the machine-learned model. The machine-learned model can be configured to generate uncorrupted subportions corresponding to corrupted subportions of the corrupted training examples. The example operations can include obtaining, from the machine-learned model, a plurality of outputs respectively generated by the machine-learned model based on the plurality of corrupted training examples. The example operations can include updating one or more parameters of the machine-learned model based on an evaluation of the plurality of outputs.

In another aspect, example embodiments of the present disclosure provide an example system including one or more processors and the example non-transitory, computer-readable medium.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example input data structure and corresponding example out for chain of thought prompting according to example aspects of some embodiments of the present disclosure;

FIG. 2 depicts a block diagram of an example input data structure and corresponding example out for chain of thought prompting according to example aspects of some embodiments of the present disclosure;

FIG. 3 depicts a block diagram of an example input data structure and corresponding example out for chain of thought prompting according to example aspects of some embodiments of the present disclosure;

FIG. 4 depicts a block diagram of an example input data structure and corresponding example out for chain of thought prompting according to example aspects of some embodiments of the present disclosure;

FIG. 5 depicts a block diagram of an example input data structure and corresponding example out for recursive prompting according to example aspects of some embodiments of the present disclosure;

FIG. 6 depicts example results for benchmark comparisons for chain of thought prompting according to example aspects of some embodiments of the present disclosure;

FIG. 7 depicts example results for benchmark comparisons for chain of thought prompting according to example aspects of some embodiments of the present disclosure;

FIG. 8 depicts example results for benchmark comparisons for chain of thought prompting according to example aspects of some embodiments of the present disclosure;

FIG. 9 depicts example results for benchmark comparisons for chain of thought prompting according to example aspects of some embodiments of the present disclosure;

FIG. 10A depicts a block diagram of an example computing system that performs chain of thought prompting according to example aspects of some embodiments of the present disclosure;

FIG. 10B depicts a block diagram of an example computing device that performs chain of thought prompting according to example aspects of some embodiments of the present disclosure;

FIG. 10C depicts a block diagram of an example computing device that performs chain of thought prompting according to example aspects of some embodiments of the present disclosure; and

FIG. 11 depicts a flow chart diagram of an example method to perform chain of thought prompting according to example aspects of some embodiments of the present disclosure.

FIG. 12 depicts a block diagram of an example pretraining framework according to example embodiments of the present disclosure.

FIG. 13A depicts a block diagram of example training examples according to example embodiments of the present disclosure.

FIG. 13B depicts a block diagram of example corrupted training examples according to example embodiments of the present disclosure.

FIG. 14A depicts a block diagram of example corrupted training examples according to example embodiments of the present disclosure.

FIG. 14B depicts a block diagram of example corrupted training examples according to example embodiments of the present disclosure.

FIG. 15 depicts a flow chart diagram of an example method to perform pretraining according to example embodiments of the present disclosure.

Reference numerals that are repeated across plural figures are intended to identify the same features in various implementations.

### DETAILED DESCRIPTION

### Overview

Generally, the present disclosure is directed to improved techniques for prompting machine-learned models to perform various tasks. Example embodiments of the present disclosure relate to prompting a machine-learned model using a “chain of thought” that traces the reasoning used to generate an output responsive to a given input. For example, a machine-learned model can be trained (e.g., in pre-training, fine tuning, etc.) to learn relationships between inputs. For instance, a machine-learned model can be trained to learn relationships between terms in an input query. Prompting a machine-learned model can include providing an instructive input query and an instructive output response before an operative query of interest. By also providing an instructive trace explaining the sequence of reasoning steps or logical states between the instructive input query and the instructive output response, example prompts according to aspects of the present disclosure can better leverage the network of learned associations to communicate more instructive context with a given prompt. In some implementations, the machine-learned model used to process the chain of thought prompt can have been pre-trained on a plurality of diversified objectives. Pre-training the model in such fashion may improve the ability of the model to process the chain of thought prompt (e.g., even when the model has a relatively smaller number of parameters).

For example, traditional model input structures can be suitable for some tasks. For instance, scaling up the size of language models has led to improvements in performance and sample efficiency. For instance, language models at the scale of 100B or more parameters have achieved strong performance on natural language processing tasks such as sentiment analysis and topic classification, even in few-shot and zero-shot settings.

However, on other tasks, even large models can struggle using traditional input and control techniques. For instance, using traditional input and control techniques, even large language models can struggle with tasks that involve slow and deliberate thinking (e.g., “system-2 tasks,” tasks with multiple steps, etc.), and includes logical, mathematical, and commonsense reasoning tasks, among others. This difficulty can arise even when models are scaled into the hundreds of billions of parameters. For example, a pre-trained GPT-3 model can struggle to perform few-shot addition on numbers with greater than three digits. Similarly, existing large-scale language model implementations can struggle to predict the result of executing Python code, even code which is a solution to a programming task the model is generally able to solve. And standard recurrent and graph neural network implementations can fail to systematically generalize when predicting the output of simple programs with loops.

Advantageously, example techniques of the present disclosure can enable machine-learned models to decompose a posed query or problem into intermediate steps that are solved individually. In some examples, this technique enables the model to resolve the intermediate steps instead of solving an entire multi-hop problem in a single forward pass, proving capacity to focus the model's processing power on more challenging intermediate steps instead of spreading the compute resources thin over all steps at once. Examples of this technique enable the model to resolve the intermediate steps in concert with resolution of the desired output value, leveraging the richer context of the reasoning trace to guide and refine the desired output value.

For example, in some embodiments, machine-learned models can be instructed to generate such chains of thought as intermediate traces. For example, single-shot or few-shot prompting using a number of instructive examples can provide a pattern that the model can understand and follow. In some examples, including an instructive trace with the instructive examples enables the model to generate its own trace when processing a query.

In some embodiments, a machine-learned model can output a single query response and trace thereof. In some embodiments, a machine-learned model can output a plurality of responses (and corresponding traces). The plurality of responses can be leveraged to determine a consistency metric. For instance, a consistency metric can be evaluated across a sampling of diverse traces (e.g., representing diverse approaches to resolving the query) and corresponding responses. For example, a set of outputs with diverse reasoning strategies can be polled to obtain a majority or plurality “vote” on the ultimate answer. In this manner, the model output can self-corroborate its “rationale” to improve the robustness of model output and improve accuracy of the ultimate answers. Compared to some prior decoding methods, a self-consistency technique according to the present disclosure can avoid the repetitiveness that can affect greedy sampling, while mitigating the stochasticity of a single random generation. Compared to prior generate-then re-rank approaches, self-consistency can avoid using a specially-trained re-ranker and can have a faster runtime (e.g., given the same number of decodes).

In some embodiments, a chain of thought can span multiple queries processed by the machine-learned model. For instance, a target query may include a complex or multi-part question. The target query can be broken down or reduced into one or more query components (e.g., using prompting or other methods, using the same or a different model, etc.). The query components can then be recursively processed by the model. For instance, a first query component can be processed in view of an initial instructive sequence (e.g., a chain-of-thought prompt as described herein, etc.). In some embodiments, each successive query component can be processed in view of prior query components and responses thereto. For instance, in this manner, the machine-learned model can self-construct an updated instructive sequence with each recursion to leverage its own prior work to build toward an ultimate response to the target query.

Example embodiments of input data structures according to aspects of the present disclosure can provide for a number of technical effects and benefits. In some embodiments, causing a machine-learned model to generate a chain of thought according to aspects of the present disclosure can provide an interpretable window into the behavior of the model, suggesting how it might have arrived at a particular answer and providing opportunities to debug where the reasoning path went wrong. Input data structures configured according to example embodiments of the present disclosure can unlock previously unrealized capabilities to understand, audit, debug, and improve the functionality of computing devices executing machine-learned models.

In some embodiments, input data structures configured according to example embodiments of the present disclosure can enable machine-learned models to be used for cross-domain tasks. For instance, a machine-learned model trained on a textual corpus may contain weights which encode a number of semantic associations between concepts. Using an input data structure configured according to the present disclosure, such a model can provide utility in resolving queries for any problem that can be formulated in a textual expression, even if the model was not trained to perform such a problem type (e.g., mathematical problems, symbolic manipulation more generally, etc.). In this manner, for example, the presently disclosed input data structures unlock the full computational power of machine-learned models to solve new problems outside of a training domain.

In some embodiments, input data structures configured according to example embodiments of the present disclosure can provide for an improved human-machine interface for inputting and processing queries. For instance, in the context of machine-learned language models, input data structures according to the present disclosure enable a user to control the model to perform complex calculations or other reasoning tasks by inputting only simple instructive strings. In this manner, the technological power of complex machine-learned language models can be made more accessible to non-technical users who may lack requisite training or other resources to, for example, fine-tune a multibillion-parameter model to perform a particular task. By improving the interface for such models, example embodiments of the present disclosure improve the capabilities of computing devices executing the models in such implementations by providing for new pathways of interaction with the models.

In some embodiments, input data structures configured according to example embodiments of the present disclosure can provide for decreased usage of computing resources to adapt a model to a given task. For instance, traditional approaches to instructing a machine-learned model to perform a given task include updating model parameter(s) based on an objective evaluated over some training input. Such an update procedure can be extremely resource intensive (e.g., computational resources, electrical resources, etc.) and may be cost-prohibitive (e.g., energy cost, time cost, etc.). In contrast, input data structures according to the present disclosure can provide for adaptation of large models (e.g., billions of parameters, trillions of parameters, etc.) without necessarily requiring additional training. For instance, input data structures according to the present disclosure can provide for improvements in model performance with just one or more instructive examples and instructive traces.

Example aspects of the present disclosure also provide systems and methods for pretraining machine learned models for diverse downstream tasks. In some embodiments, systems and methods of the present disclosure leverage a plurality of pretraining objectives to simulate diverse implementations. In some embodiments, the pretraining objectives can be based on a pretraining objective framework that provides for efficient construction of a diverse set of pretraining objectives by adjusting parameters of the common framework. In some implementations, a model trained using the pre-diverse training objectives can provide improved performance when used to process chain of thought prompts, as described herein. For example, a model with a relatively smaller number of parameters may still be able to perform high quality processing of chain of thought prompts if trained using the diversified objectives described herein.

A plurality of pretraining objectives can be configured based on a shared pretraining objective framework. For instance, a denoising objective framework can correspond to corrupting one or more selected subportion(s) of a training example (e.g., “noising”) and subsequently predicting/recovering the selected subportion(s) based on a remainder of the training example, such that the original training example can be reconstructed (e.g., “denoising”). A diverse plurality of pretraining objectives can be obtained by adjusting one or more configuration parameters of the shared pretraining objective framework. For example, the one or more configuration parameters can characterize a quantity of the selected subportion(s), a size of the selected subportion(s), a rate at which the selected subportion(s) are corrupted, etc.

Advantageously, systems and methods according to example aspects of the present disclosure can provide for a unified approach to model selection, development, and implementation. For example, in some embodiments, a machine-learned model can be configured for processing sequential information (e.g., language strings, genetic sequencing, other sequenced data). For instance, the model can be configured to understand, generate, respond to, or otherwise interact with sequences of data. Pretraining a model according to example embodiments of the present disclosure can provide a “universal” model effective to perform a variety of different downstream tasks with respect to sequenced data (e.g., the same or different sequenced data), optionally with or without subsequent fine-tuning.

Traditional techniques, in contrast, point to model selection based on the downstream tasks. The plethora of distinct model arrangements, architectures, training recipes, training datasets, etc. can be overwhelming, leading to uninformed choices or otherwise suboptimal model implementations. Furthermore, even if a model may be appropriately selected for a given task, that model may need to be reconfigured or even replaced if the tasks or other requirements change. For example, traditional approaches to processing sequenced data have often relied on different categories of pretraining approaches. For instance, in the context of natural language processing, one prior approach includes pretraining with a language-modeling objective which unidirectionally generates sequences of text based on preceding textual content. Another approach includes pretraining with a masked language objective which identifies masked text based on surrounding text (e.g., bidirectionally). But these pretraining objectives have generally proved inadequate for diverse implementations: for example, open-text generation and prompt-based learning can be an unfavorable setting for traditional masked language objectives, whereas traditional language modeling approaches can be unduly inhibited by purely unidirectional causality.

Therefore, systems and methods according to example aspects of the present disclosure can provide a number of technical effects and advantages over prior approaches. For instance, a unified approach according to example aspects of the present disclosure can provide for implementation of a small number models (e.g., one model) in place of many models (e.g., multiple models). This can decrease the computational complexity of deploying the models, training the models, updating the models, deactivating the models, etc. In this manner, for instance, decreased computational resources can be used to perform model operations with the unified techniques disclosed herein. Decreased storage can be used to store a small number of models (e.g., one model) in place of many models (e.g., multiple models). Decreased network transmissions can be used to implement a small number of models (e.g., one model) in place of many models (e.g., multiple models) on one or more remote device(s) (e.g., client devices connected to a server device). Efficiency of update and patch cycles can be improved by devoting resources (e.g., computational resources, human resources, etc.) to managing and versioning a small number of models (e.g., one model) in place of many models (e.g., multiple models). By using a model trained with a diversified pretraining approach according to example aspects of the present disclosure, a target performance can be achieved with less computational overhead by leveraging a small number of models (e.g., one model) in place of many models (e.g., multiple models). Lower latency can be achieved by using a small number of models (e.g., one model) instead of switching between many models (e.g., multiple models).

Furthermore, systems and methods according to example aspects of the present disclosure can provide for improved performance across task domains. For instance, a diversified pretraining approach according to example aspects of the present disclosure can provide for improved (e.g., more accurate, more precise, less expensive, less prone to error, etc.) processing of model inputs across task domains (e.g., including chain of thought prompt-based tasks). For instance, in real-world deployment scenarios in which tasks may not necessarily be neatly categorized into separate domains, a model trained with a diversified pretraining approach according to example aspects of the present disclosure can provide for improved real-world performance and perform well in mixed or cross-domain tasks.

Further, the ability of a language model to perform chain of thought prompt-based tasks can be improved when pre-trained using the diversified pre-training techniques described herein. This can enable the size of the model to be reduced (e.g., in terms of number of parameters) while still demonstrating high accuracy or other performance metrics. The ability to reduce the size of the model while retaining performance can result in savings of computational resources such as reduced usage of memory, processors, and/or network bandwidth.

Furthermore, systems and methods according to example aspects of the present disclosure can provide for improved robustness from the diverse pretraining. For example, a model pretrained according to example aspects of the present disclosure with diverse pretraining objectives can provide for improved response in new or unfamiliar contexts based on the diverse exposure to different objectives in pretraining. For example, traditional adversarial attacks may be less effective when the model is less easily disrupted by different inputs. In this manner, additionally, for example, models pretrained with diverse objectives according to example aspects of the present disclosure can provide for improved robustness in real-world implementations in which tasks may not necessarily be neatly categorized or curated.

Furthermore, systems and methods according to example aspects of the present disclosure are well suited to pretraining transformer models. For instance, example techniques described herein provide for diverse pretraining objectives that leverage internal parallel structures and processing streams of a transformer model to attend bidirectionally over inputs to the model to recover corrupted inputs. In some embodiments, transformer models can include effectively parallelized computation of multi-headed attention. In this manner, for instance, examples of inherently parallelizable transformer models can be better pretrained for immediate deployment and/or further fine-tuning, offering improvements in scalability and distributed computation by leveraging a small number of transformer models (e.g., one transformer model) in place of many varying models (e.g., multiple models) that may not offer the same advantages at scale.

With reference now to the Figures, example embodiments of the present disclosure will be discussed in further detail.

### Example Model Prompting Configurations

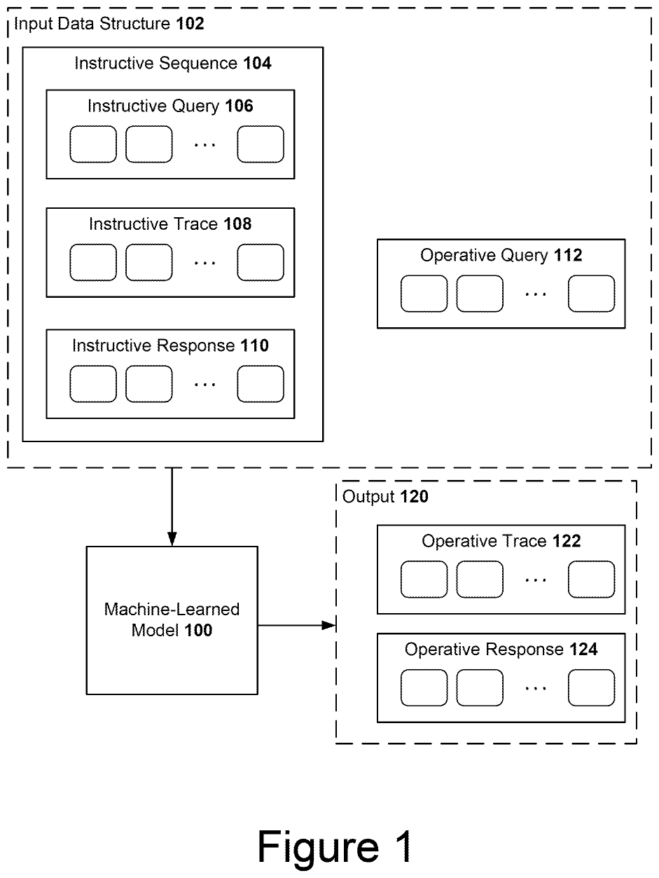

FIG. 1 depicts an example configuration of prompting a machine-learned model 100 according to aspects of the present disclosure. An input data structure 102 can include an instructive sequence 104 that contains an instructive query 106, an instructive trace 108, and an instructive response 110. Multiple different instructive sequences 104 can be provided in the input data structure 102. The input data structure 102 can also include an operative query 112. The instructive query 106, instructive trace 108, instructive response 110, and operative query 112 can contain embedded values. For instance, an embedded value can include a tokenized representation of an input string (e.g., text string, symbolic string, etc.). In some embodiments, an embedded value can include a tokenized representation of other data (e.g., image data, etc.).

In some embodiments, the machine-learned model 100 includes a neural network trained to understand and interpret inputs to generate an output. For instance, in some embodiments, the machine-learned model 100 includes a neural network trained to understand and interpret text or other symbolic inputs to extract semantic meaning therefrom, including to respond to instructions provided in such inputs. In some embodiments, the machine-learned model 100 includes a neural network trained to understand and interpret images or other data inputs more generally to extract meaning therefrom, including to respond to instructions provided in such inputs.

In general, the techniques and input data structures of the present disclosure can be implemented using and adapted for a variety of model architectures. In some embodiments, the machine-learned model 100 is configured to attend over the instructive sequence 204 when processing the operative query 112. For instance, in some embodiments, the machine-learned model 100 can include one or more transformer architectures (e.g., encoder only, decoder only, encoder and decoder, etc.).

In some embodiments, the instructive query 104 can present substantially any type of problem, question, or task to be performed. For instance, the instructive query 104 can include substantially any problem capable of being explained, reasoned, or otherwise expressed with symbols, images, language, etc. For example, the instructive query 104 can include mathematical queries, logic queries, knowledge queries, generative queries, summary queries, analytics queries, retrieval queries, image processing queries, etc.

In some embodiments, the instructive trace 108 can include one or more intermediate states from the instructive query 106 to the instructive response 110. For example, intermediate states can include intermediate values associated with component subtasks, declarations of knowns determined (explicitly or implicitly) from the instructive query, logical steps to progress from a problem to a solution, a log of subtasks performed to generate the instructive response 110, etc.

The instructive response 110 can include the fulfillment of the instructive query 106. For instance, in some embodiments of a mathematical instructive query 106, the instructive response 110 can include a numerical solution, an analytical or symbolic solution, etc. In some embodiments, for a knowledge instructive query 106, the instructive response 110 can include returning the requested knowledge, etc.

In some embodiments, the operative query 112 can be of a similar type of query to the instructive query 106. In some embodiments, the operative query 112 can be of a different type of query to the instructive query 106 (e.g., when multiple instructive sequences 104 are provided).

In some embodiments, the instructive query 106 and operative query 112 can contain input flag(s) and output flag(s). For instance, the instructive query 106 can contain an input flag indicating a query start position and an output flag indicating a portion to be generated by the model 100 (e.g., a subsequent portion of the instructive sequence 104).

Based on the input data structure 102, the machine-learned model 100 can generate an output 120. In some embodiments, the output 120 can contain an operative trace 122 and an operative response 124. Generally, the operative response 124 can include a fulfillment of the operative query 112 (e.g., including an expression of an inability to fulfill the query, etc.). In some embodiments, the operative trace 112 can be generated based on a pattern set by one or more instructive traces in the input data structure 102. In some embodiments, the operative response 124 can be generated to relate to the operative trace 122 and the operative query 112 based on a pattern set by the instructive sequence(s) 104.

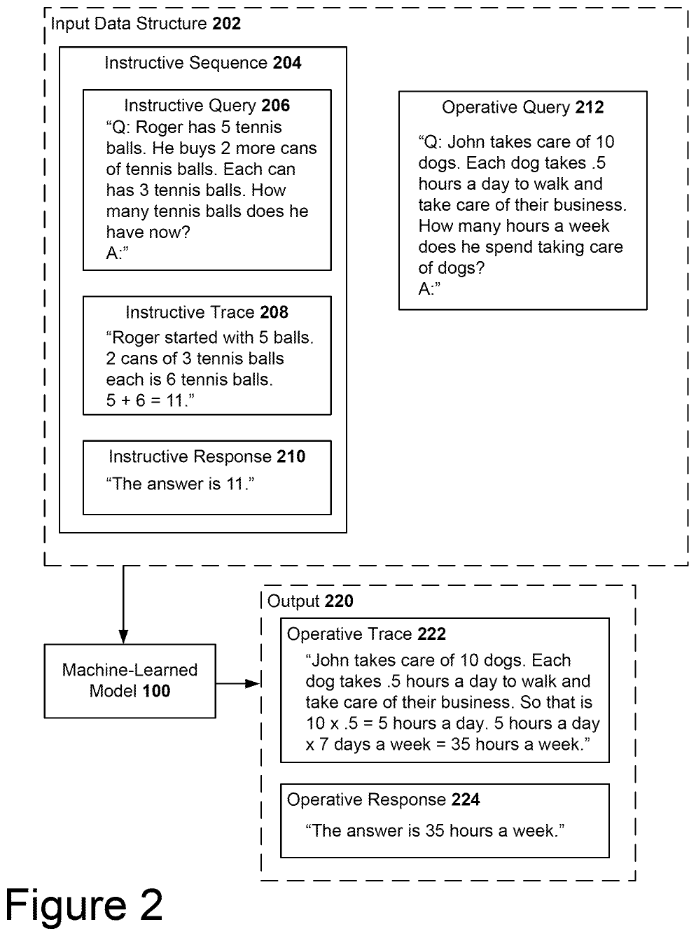

FIG. 2 illustrates one example implementation of an input data structure 202 according to aspects of the present disclosure. Instructive sequence 204 can include an instructive query 206 which embeds, represents, or otherwise is descriptive of a query corresponding to the string “Q: Roger has 5 tennis balls. He buys 2 more cans of tennis balls. Each can has 3 tennis balls. How many tennis balls does he have now? A:” In the example instructive query 206, “Q:” can correspond to an input flag indicating the start of an input query. In the example instructive query 206, “A:” can correspond to an output flag indicating the start of a portion to be provided in response to the instructive query 206.

Instructive sequence 204 can include an instructive trace 208 documenting intermediate states from the instructive query 206 to the instructive response 210. For instance, although the direct answer to the posed query is captured by the instructive response 210, “The answer is 11,” the instructive trace 208 can capture a series of intermediates (or the “chain of thought”) leading to the ultimate answer. For instance, a first intermediate state can include a declaration of a known: “Roger started with 5 balls.” A second intermediate state can include a statement of multiplication based on the query values: “2 cans of 3 tennis balls each is 6 tennis balls.” A third intermediate state can include a summation step (e.g., optionally numeric, in natural language, etc.): “5+6=11.”

Operative query 212 can include a query of the same type as at least one instructive query 206. For instance, operative query 212 can include a mathematical word problem of a similar type as the instructive query 206: “Q: John takes care of 10 dogs. Each dog takes 0.5 hours a day to walk and take care of their business. How many hours a week does he spend taking care of dogs? A:”

The machine-learned model 100 can process the input data structure 202 to generate output 220. The output 220 can include an operative trace 222 and an operative response 224. For example, the operative trace 222 can be generated to include one or more intermediate states of reasoning/solution from the operative query 212 to the operative response 224. For instance, a first intermediate state can include a declarative statement of an explicit known, “John takes care of 10 dogs.” A second intermediate state can include, for example, another declarative statement of an explicit known, “Each dog takes 0.5 hours a day to walk and take care of their business.” A third intermediate state can include, for example, a statement of multiplication based on the explicit knowns, “So that is 10×0.5=5 hours a day.” A fourth intermediate state can include, for example, a statement of multiplication based on an implicit known regarding the number of days in a week, “5 hours a day×7 days a week=35 hours a week.” In this manner, for example, the operative trace 222 can trace intermediate state(s) from the operative query 212 to the operative response 224.

In some embodiments, the respective responses (e.g., instructive response, operative response) can include the respective traces. For instance, in some examples the desired response is the trace. For instance, example embodiments can be implemented to obtain traces of computer-executable script operation.

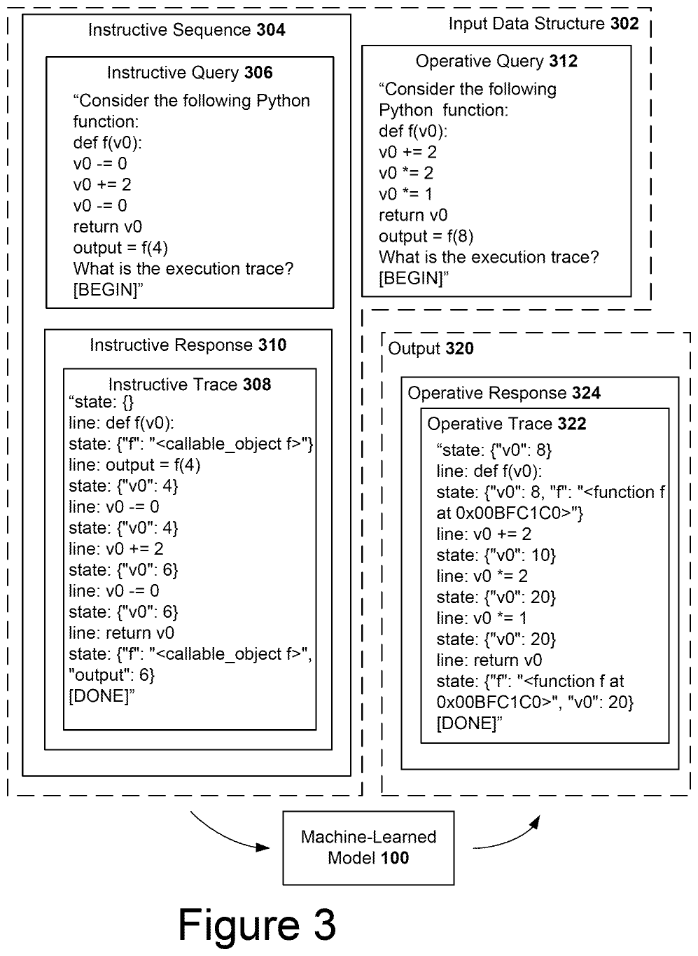

FIG. 3 depicts one example implementation of an input data structure 302 in which an instructive sequence 304 contains an instructive query 306 descriptive of a Python program (e.g., a tokenized representation thereof, etc.). In some examples, the instructive query 306 can include an input flag or an output flag. For instance, FIG. 3 depicts an input flag “Consider the following Python function:” and an output flag “What is the execution trace? [BEGIN].” The instructive trace 308 can form part of the instructive response 310, for example, because fulfillment of the instructive query 304 corresponds to generation of the trace itself. The operative query 312 includes the input flag and output flag along with a new Python program for tracing. Accordingly, the output 320 generated by the machine-learned model 100 can include an operative trace 322 forming part of the operative response 324.

In some embodiments, the machine-learned model 100 can directly generate an output for fulfilling the operative query. In some embodiments, fulfilling the operative query can include sampling a plurality of outputs to determine a response satisfying a consistency metric.

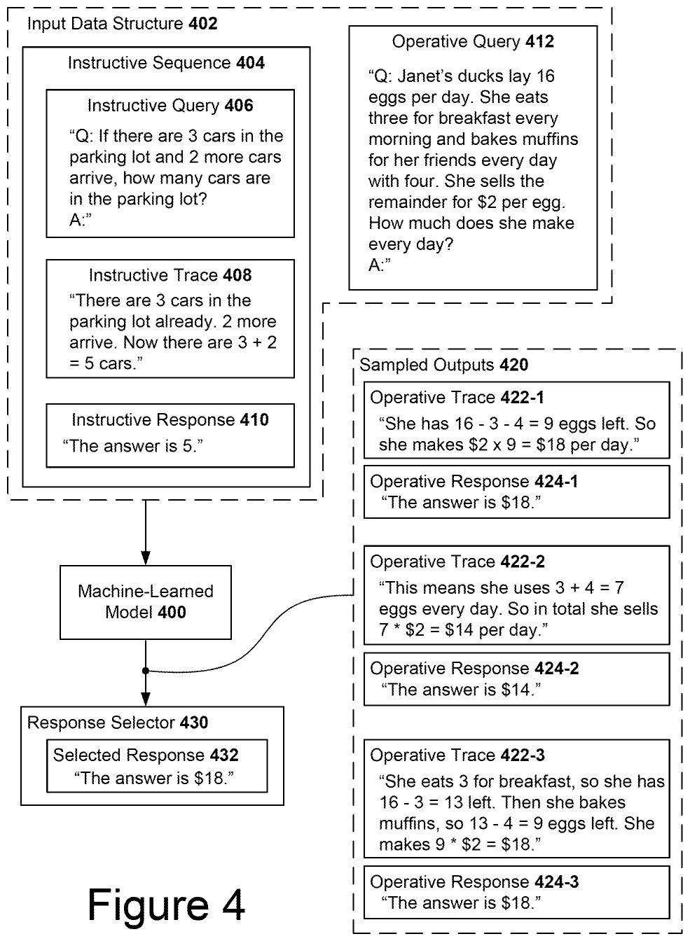

FIG. 4 provides an example illustration of an input data structure 402 containing an instructive sequence 404 (including instructive query 406, instructive trace 408, and instructive response 410) and an operative query 412. A machine-learned model 400 can be configured to output a plurality of outputs, including a plurality of operative traces corresponding to a plurality of operative responses. A subset can be sampled, for example, as sampled outputs 420, containing a first sampled output (operative trace 422-1, operative response 424-1), a second sampled output (operative trace 422-2, operative response 424-2), and a third sampled output (operative trace 422-3, operative response 424-3).

In some embodiments, sampled outputs 420 can include a number of outputs sampled from an output layer of a machine-learned model 400. In some embodiments, sampled outputs 420 can be sampled from a probability distribution of the outputs (e.g., of a probability distribution over pairs of traces and responses). In some embodiments, samples are selected according to any suitable sampling scheme. In some embodiments, outputs are randomly sampled. In some embodiments, outputs can be sampled based on a ranked probability (e.g., top-K outputs). In some embodiments, outputs can be sampled for diverse traces.

In some embodiments, a plurality or majority of diverse traces that arrive at the same ultimate resolution can be indicative of a response associated with a higher confidence. Accordingly, in some embodiments, a vote is taken over the sampled outputs (e.g., a plurality vote, a majority vote). For instance, a response selector 430 can determine that the ultimate answer of $18 is indicated in two out of the three sampled outputs 420. In this manner, for example, a selected response 432 of $18 can be obtained.

In some embodiments, evaluation of the consistency metric can be expressed as applying a marginalization over the traces in the conditional probability P(response, trace|query) of each output given a query.

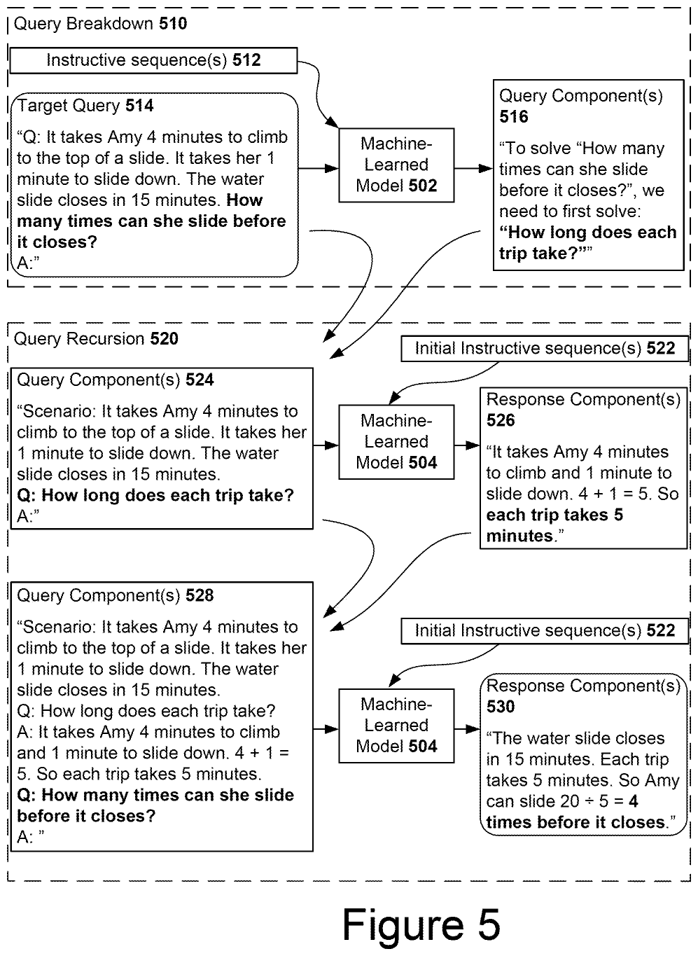

FIG. 5 depicts a block diagram of an example processing flow for performing recursive prompting according to example aspects of the present disclosure. For instance, a machine-learned model pipeline can include one or more models 502, 504. The models 502 and 504 may be the same or different. For instance, any one or both of model(s) 502, 504 can be or contain models 100, 400, etc.

In a query breakdown stage 510, for example, a machine-learned model 502 can reduce a complex problem into one or more component problems. For instance, in some embodiments, the model 502 can be prompted to perform the reduction with one or more instructive sequence(s) 512 (e.g., which can optionally contain instructive traces). In some embodiments, the target query 514 is input to the model 502. For instance, the target query 514 can include a scenario providing context for a question to be answered (e.g., example question emphasized in bold in FIG. 5). The model 502 can generate one or more query components 516. In some embodiments, a query component can include a question that asks for part of an overall solution. In some embodiments, a query component can include a question that asks for a preliminary information component that can be used to obtain an overall solution. In some embodiments, a query component can include a question that asks for a logical complement, corollary, or other related component that may advantageously be easier to resolve.

In a query recursion stage 520, a machine-learned model 504 can recursively process the query components 516 and optionally the initial target query 514. For instance, in some embodiments, the machine-learned model 504 can be prompted with initial instructive sequences 522 to answer the first query component. For instance, query component(s) 524 can include the first query component from query components 516, optionally in combination with the scenario from the target query 514. In some embodiments, the initial instructive sequence(s) 522 can include one or more instructive queries, instructive traces, and instructive responses according to example embodiments of the present disclosure. In some embodiments, the query component(s) can correspond to an operative query (e.g., as described with respect to FIGS. 1 to 4).

On one pass of query recursion 520, the model 504 can generate response component(s) 526 based on the input query component(s) and initial instructive sequence(s) 522. For instance, the response component(s) 526 can include an operative trace and an operative response.

To perform another pass of query recursion 520, a new instructive sequence can be composed from the body of prior knowledge about the problem at hand, which can include new information generated by the model 504. For instance, query component(s) 528 can incorporate query component(s) 524 as well as the response component(s) 526. In this manner, the prior work of the model 504 can effectively become an instructive sequence including instructive queries, instructive traces, and instructive responses. Optionally, the initial instructive sequences 522 can be retained for input together with the query component(s) 528. In this manner, for instance, the model 504 can process additional query component(s) (e.g., the original target query, in bold) by leveraging its prior outputs to generate response component(s) 530.

Query recursion 520 can include, in some embodiments, a plurality of iterations. In some embodiments, the iterative recursion can provide for self-constructed instructive sequences. In some embodiments, this can help the machine-learned model leverage its full power over individual component queries while retaining the ability to build on its own prior work. In some embodiments, this can improve generalization from easy to difficult problems (e.g., easy problems explained via instruction, with inference performed over more difficult problems).

For example, in some embodiments, the query breakdown 510 can provide for an ordered set of query component(s) 516. For instance, in some embodiments, the query component(s) 516 can include an ordering from basic (or foundational) queries to complex (or follow-on) queries. In some embodiments, the set of query components is naturally ordered by appending the task from the original target query to the set of query component(s) 516 generated by the model. In this manner, for instance, the query component(s) 516 can include tractable component queries that can be resolved before tackling the task from the target query 514 itself. FIG. 5 illustrates this example flow.

### Example Results: Arithmetic Reasoning

Example results are presented herein for illustration purposes only. It is to be understood that the various configurations presented in the examples are selected for the purpose of illustration and comparison and are not to be interpreted as somehow limiting the scope of disclosure.

First, example results will be discussed with respect to the mathematical word problem type query depicted in FIG. 2. Such queries probe the ability of language models to perform arithmetic reasoning while focusing on problems solvable by elementary school children (ages 6-10). Though such problems can be simple for humans, arithmetic reasoning is a task where language models can exhibit a flat scaling curve (e.g., model performance increase can taper as model size increases). Advantageously, providing a prompt comprising a few instructive traces according to the present disclosure can dramatically improve performance on difficult math word problems for large language models. When scaled to 540B parameters, chain of thought prompting can perform comparably with task-specific finetuned models on a variety of tasks, including surpassing the GSM8K benchmark introduced by Cobbe et al., Training Verifiers to Solve Math Word Problems, ARXIV.ORG (Oct. 27, 2021). For arithmetic reasoning examples discussed herein, the following datasets are used:
(1) SingleOp (Roy et al., Reasoning about Quantities in Natural Language, Transactions of the Association for Computational Linguistics, 2015. doi: 10.1162/tacl_a_00118);
(2) SingleEq (Koncel-Kedziorski et al., MAWPS: A math word problem repository, In Proceedings of the 2016 Conference of the North American Chapter of the Association for Computational Linguistics: Human Language Technologies, 2016. doi: 10.18653/v1/N16-1136);
(3) AddSub, (Hosseini et al., Learning to solve arithmetic word problems with verb categorization, In Proceedings of the 2014 Conference on Empirical Methods in Natural Language Processing (EMNLP), 2014. doi: 10.3115/v1/D14-1058);
(4) ASDiv (Miao et al., A diverse corpus for evaluating and developing English math word problem solvers, In Proceedings of the 58th Annual Meeting of the Association for Computational Linguistics, 2020. doi: 10.18653/v1/2020.acl-main.92);
(5) MultiArith, (Roy et al., Solving general arithmetic word problems, In Proceedings of the 2015 Conference on Empirical Methods in Natural Language Processing, 2015 doi: 10.18653/v1/D15-1202); and
(6) GSM8K (Cobbe et al., Training Verifiers to Solve Math Word Problems, ARXIV.ORG (Oct. 27, 2021)).

As a baseline approach, standard few-shot prompting results are provided in which a language model is given in-context exemplars of input—output pairs before outputting a prediction for a test-time example. Exemplars are formatted as questions and answers before being fed into the model, and the model gives the answer directly.

For the example chain-of-thought prompting results, a set of eight instructive sequences are used. This set is provided in Table 1.

The results are generated by using two collections of dense left-to-right, decoder-only transformer language models. The first collection is based on LaMDA (Thoppilan et al., Lamda: Language models for dialog applications, arXiv preprint arXiv:2201.08239), which has models of 422M, 2B, 8B, 68B, and 137B parameters. The second collection of models is PaLM (Chowdhery et al., PaLM: Scaling language modeling with Pathways, arXiv preprint arXiv:2204.02311, 2022), which has sizes of 8B, 62B, and 535B parameters. In the present examples, outputs are sampled from the model using greedy decoding. For LaMDA, results are reported averaged over five random seeds, where each seed had a different randomly shuffled order of exemplars. LaMDA experiments did not show large variance among different seeds, so PaLM results are reported using a single random seed.

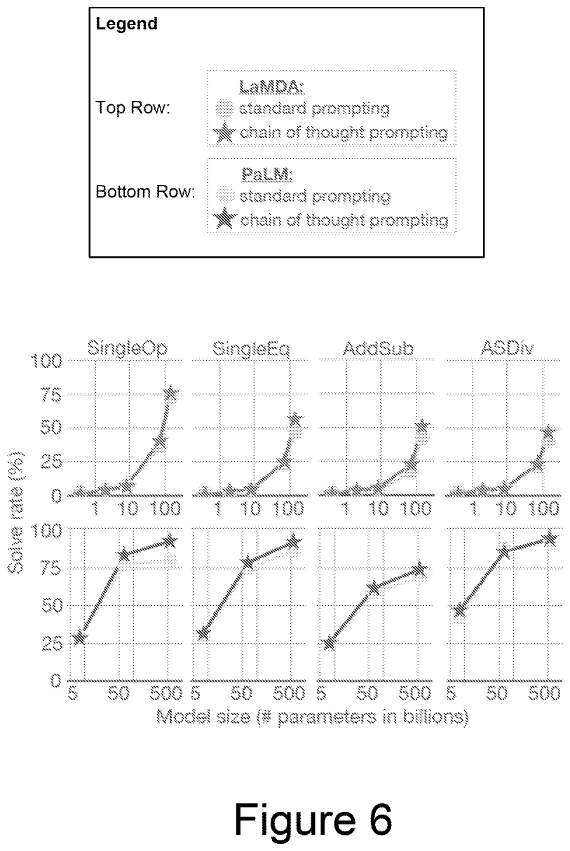

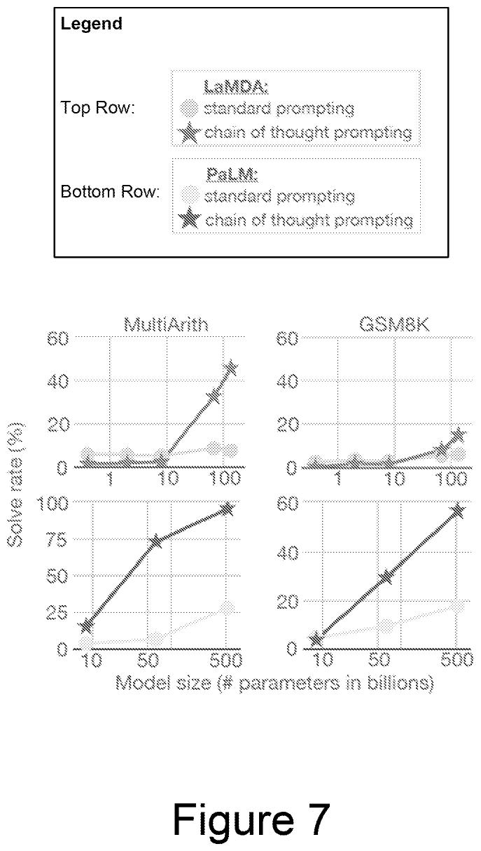

Example results are presented in FIGS. 6 and 7.

TABLE 1-1
Instructive Sequences for Arithmetic Reasoning Examples

Q: There are 15 trees in the grove. Grove workers will plant trees in the grove today. After
they are done, there will be 21 trees. How many trees did the grove workers plant today?
A: There are 15 trees originally. Then there were 21 trees after some more were planted. So
there must have been 21 − 15 = 6. The answer is 6.
Q: If there are 3 cars in the parking lot and 2 more cars arrive, how many cars are in the
parking lot?
A: There are originally 3 cars. 2 more cars arrive. 3 + 2 = 5. The answer is 5.
Q: Leah had 32 chocolates and her sister had 42. If they ate 35, how many pieces do they
have left in total?
A: Originally, Leah had 32 chocolates. Her sister had 42. So in total they had 32 + 42 = 74.
After eating 35, they had 74 − 35 = 39. The answer is 39.
Q: Jason had 20 lollipops. He gave Denny some lollipops. Now Jason has 12 lollipops. How
many lollipops did Jason give to Denny?
A: Jason started with 20 lollipops. Then he had 12 after giving some to Denny. So he gave
Denny 20 − 12 = 8. The answer is 8
Q: Shawn has five toys. For Christmas, he got two toys each from his mom and dad. How
many toys does he have now?
A: Shawn started with 5 toys. If he got 2 toys each from his mom and dad, then that is 4 more
toys. 5 + 4 = 9. The answer is 9.
Q: There were nine computers in the server room. Five more computers were installed each
day, from monday to thursday. How many computers are now in the server room?
A: There were originally 9 computers. For each of 4 days, 5 more computers were added. So
5 * 4 = 20 computers were added. 9 + 20 is 29. The answer is 29.
Q: Michael had 58 golf balls. On tuesday, he lost 23 golf balls. On wednesday, he lost 2
more. How many golf balls did he have at the end of wednesday?
A: Michael started with 58 golf balls. After losing 23 on tuesday, he had 58 − 23 = 35. After
losing 2 more, he had 35 − 2 = 33 golf balls. The answer is 33.
Q: Olivia has $23. She bought five bagels for $3 each. How much money does she have left?
A: Olivia had 23 dollars. 5 bagels for 3 dollars each will be 5 × 3 = 15 dollars. So she has 23 −
15 dollars left. 23 − 15 is 8. The answer is 8.

### Example Results: Symbolic Reasoning

Second, example results are presented for performing symbolic reasoning tasks. Although the symbolic reasoning tasks discussed here are generally simple for humans, machine-learned models can typically exhibit a flat scaling curve for such tasks. In some examples shown here, solving intermediate steps of a symbolic reasoning task according to aspects of the present disclosure using chain of thought prompting allows models to perform tasks that are not solvable with standard prompting alone.

Three tasks are presented herein for the sake of illustration of symbolic manipulation functions: Last letter concatenation (to concatenate the last letters of words in randomly concatenated names from the top one-thousand first and last names from name census data); Reverse list (to reverse the order of a list of randomly sampled names of everyday objects); and Coin flip (to answer whether a coin is still heads up after people either flip or do not flip the coin).

For each task a test set is split into an in-domain test set for which examples had the same number of steps as the training/few-shot exemplars, as well as two out-of-domain (OOD) test sets, for which evaluation examples had more steps than those in the exemplars. For last letter concatenation, the model only sees exemplars of names with two words, and then performs last letter concatenation on names with three and four words. The same is done for the number of items in the reverse list task (in-domain=5, OOD={6, 7}) and the number of potential flips in the coin flip task (in-domain=2, OOD={3, 4}).

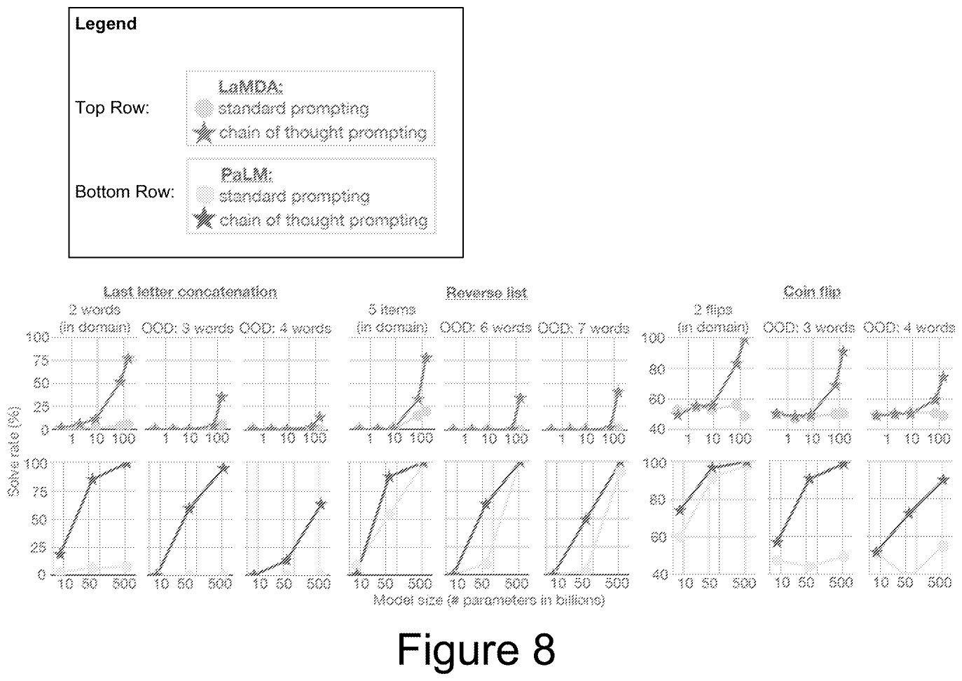

Example results are given in FIG. 8.

TABLE 1-2
Few-shot exemplars for full chain of thought prompt
for the last letter concatenation task.

Q: Take the last letters of the words in “Elon Musk” and concatenate them.
A: The last letter of “Elon” is “n”. The last letter of “Musk” is “k”. Concatenating them is
“nk”. The answer is nk.
Q: Take the last letters of the words in “Larry Page” and concatenate them.
A: The last letter of “Larry” is “y”. The last letter of “Page” is “e”. Concatenating them is
“ye”. The answer is ye.
Q: Take the last letters of the words in “Sergey Brin” and concatenate them.
A: The last letter of “Sergey” is “y”. The last letter of “Brin” is “n”. Concatenating them is
“yn”. The answer is yn.
Q: Take the last letters of the words in “Bill Gates” and concatenate them.
A: The last letter of “Bill” is “l”. The last letter of “Gates” is “s”. Concatenating them is “ls”
The answer is ls.

TABLE 1-3
Few-shot exemplars for chain of thought prompt for the reverse list task.

Q: Reverse the sequence “cigar, umbrella, key, gum, alarm”.
A: First is cigar. Second is umbrella. Third is key. Fourth is gum. Fifth is alarm. Now to
reverse, change the order to: Fifth is alarm. Fourth is gum. Third is key. Second is umbrella.
First is cigar. So the answer is “alarm, gum, key, umbrella, cigar”.
Q: Reverse the sequence “player, passport, umbrella, bottle, watch”.
A: First is player. Second is passport. Third is umbrella. Fourth is bottle. Fifth is watch. Now
to reverse, change the order to: Fifth is watch. Fourth is bottle. Third is umbrella. Second is
passport. First is player. So the answer is “watch, bottle, umbrella, passport, player”.
Q: Reverse the sequence “coin, postcard, case, pen, wallet”.
A: First is coin. Second is postcard. Third is case. Fourth is pen. Fifth is wallet. Now to
reverse, change the order to: Fifth is wallet. Fourth is pen. Third is case. Second is postcard.
First is coin. So the answer is “wallet, pen, case, postcard, coin”.
Q: Reverse the sequence “laptop, lipstick, pen, bin, clock”.
A: First is laptop. Second is lipstick. Third is pen. Fourth is bin. Fifth is clock. Now to
reverse, change the order to: Fifth is clock. Fourth is bin. Third is pen. Second is lipstick.
First is
laptop. So the answer is “clock, bin, pen, lipstick, laptop”.
Q: Reverse the sequence “key, pen, screen, file, cigar”.
A: First is key. Second is pen. Third is screen. Fourth is file. Fifth is cigar. Now to reverse,
change the order to: Fifth is cigar. Fourth is file. Third is screen. Second is pen. First is key.
So
the answer is “cigar, file, screen, pen, key”.
Q: Reverse the sequence “card, stamp, book, water, glasses”.
A: First is card. Second is stamp. Third is book. Fourth is water. Fifth is glasses. Now to
reverse, change the order to: Fifth is glasses. Fourth is water. Third is book. Second is stamp.
First is card. The answer is 29.
Q: Reverse the sequence “clock, coin, bottle, head, postcard”.
A: First is clock. Second is coin. Third is bottle. Fourth is head. Fifth is postcard. Now to
reverse, change the order to: Fifth is postcard. Fourth is head. Third is bottle. Second is coin.
First is clock. So the answer is “postcard, head, bottle, coin, clock”.
Q: Reverse the sequence “battery, glasses, lighter, water, scissors”.
A: First is battery. Second is glasses. Third is lighter. Fourth is water. Fifth is scissors. Now
to reverse, change the order to: Fifth is scissors. Fourth is water. Third is lighter. Second is
glasses. First is battery. So the answer is “scissors, water, lighter, glasses, battery”.

TABLE 1-4
Few-shot exemplars for full chain of thought prompt for the coinflip task.

Q: A coin is heads up. Ka flips the coin. Sherrie flips the coin. Is the coin still heads up?
A: The coin was flipped by Ka and Sherrie. So the coin was flipped 2 times, which is an even
number. The coin started heads up, so after an even number of flips, it will still be heads up.
So the answer is yes.
Q: A coin is heads up. Jamey flips the coin. Teressa flips the coin. Is the coin still heads up?
A: The coin was flipped by Jamey and Teressa. So the coin was flipped 2 times, which is an
even number. The coin started heads up, so after an even number of flips, it will still be heads
up. So the answer is yes.
Q: A coin is heads up. Maybelle flips the coin. Shalonda does not flip the coin. Is the coin
still heads up?
A: The coin was flipped by Maybelle. So the coin was flipped 1 time, which is an odd
number. The coin started heads up, so after an odd number of flips, it will be tails up. So the
answer is no.
Q: A coin is heads up. Millicent does not flip the coin. Conception flips the coin. Is the coin
still heads up?
A: The coin was flipped by Conception. So the coin was flipped 1 time, which is an odd
number. The coin started heads up, so after an odd number of flips, it will be tails up. So the
answer is no.
Q: A coin is heads up. Sal flips the coin. Raymond does not flip the coin. Is the coin still
heads up?
A: The coin was flipped by Sal. So the coin was flipped 1 time, which is an odd number. The
coin started heads up, so after an odd number of flips, it will be tails up. So the answer is no.
Q: A coin is heads up. Conception flips the coin. Kristian does not flip the coin. Is the coin
still heads up?
A: The coin was flipped by Conception. So the coin was flipped 1 time, which is an odd
number. The coin started heads up, so after an odd number of flips, it will be tails up. So the
answer
is no.
Q: A coin is heads up. Inga does not flip the coin. Elanor does not flip the coin. Is the coin
still heads up?
A: The coin was flipped by no one. So the coin was flipped 0 times. The coin started heads
up, and it was not flipped, so it is still heads up. So the answer is yes.
Q: A coin is heads up. Ryan flips the coin. Shaunda flips the coin. Is the coin still heads up?
A: The coin was flipped by Ryan and Shaunda. So the coin was flipped 2 times, which is an
even number. The coin started heads up, so after an even number of flips, it will still be heads
up. So the answer is yes.

### Example Results: “Common Sense” Reasoning

Third, example results are presented for tasks of reasoning about physical and human interactions under the presumption of general background knowledge. Four benchmark datasets are selected for the example results:
(1) CommonsenseQA (Talmor et al., CommonsenseQA: A question answering challenge targeting commonsense knowledge, In Proceedings of the 2019 Conference of the North American Chapter of the Association for Computational Linguistics: Human Chain of Thought Prompting Elicits Reasoning in Large Language Models Language Technologies, Volume 1 (Long and Short Papers), 2019. doi: 10.18653/v1/N19-1421) includes commonsense reasoning questions about the world involving complex semantics that often require prior knowledge;
(2) StrategyQA (Geva et al., Did aristotle use a laptop? A question answering benchmark with implicit reasoning strategies, Transactions of the Association for Computational Linguistics, 2021. doi: 10.1162/tacl_a_00370) includes inference of a multi-hop strategy to answer questions;
(3) Date Understanding, which involves inferring a date from a given context; and
(4) Sports Understanding, which involves determining whether a sentence relating to sports is plausible or implausible;
with (3) and (4) from (BIG-bench collaboration, Beyond the imitation game: Measuring and extrapolating the capabilities of language models, In preparation, 2021, https://github.com/google/BIG-bench).

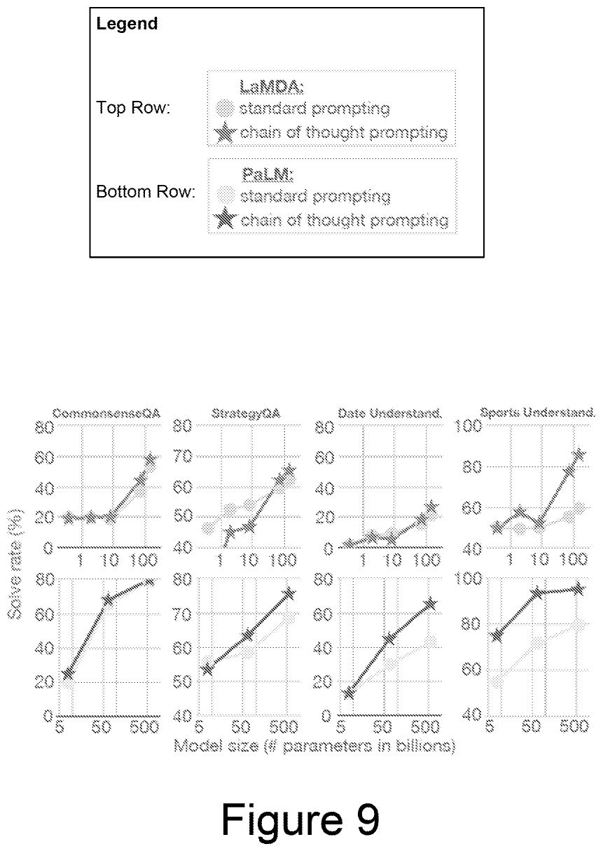

Example results are given in FIG. 9.

TABLE 1-5
Few-shot exemplars for full chain of thought prompt for CommonsenseQA.

Q: What do people use to absorb extra ink from a fountain pen? Answer Choices: (a) shirt
pocket (b) calligrapher's hand (c) inkwell (d) desk drawer (e) blotter
A: The answer must be an item that can absorb ink. Of the above choices, only blotters are
used to absorb ink. So the answer is (e).
Q: What home entertainment equipment requires cable? Answer Choices: (a) radio shack (b)
substation (c) television (d) cabinet
A: The answer must require cable. Of the above choices, only television requires cable. So
the answer is (c).
Q: The fox walked from the city into the forest, what was it looking for? Answer Choices: (a)
pretty flowers (b) hen house (c) natural habitat (d) storybook
A: The answer must be something in the forest. Of the above choices, only natural habitat is
in the forest. So the answer is (b).
Q: Sammy wanted to go to where the people were. Where might he go? Answer Choices: (a)
populated areas (b) race track (c) desert (d) apartment (e) roadblock
A: The answer must be a place with a lot of people. Of the above choices, only populated
areas have a lot of people. So the answer is (a).
Q: Where do you put your grapes just before checking out? Answer Choices: (a) mouth (b)
grocery cart (c) super market (d) fruit basket (e) fruit market
A: The answer should be the place where grocery items are placed before checking out. Of
the above choices, grocery cart makes the most sense for holding grocery items. So the
answer
is (b).
Q: Google Maps and other highway and street GPS services have replaced what? Answer
Choices: (a) united states (b) mexico (c) countryside (d) atlas
A: The answer must be something that used to do what Google Maps and GPS services do,
which is to give directions. Of the above choices, only atlases are used to give directions. So
the
answer is (d).
Q: Before getting a divorce, what did the wife feel who was doing all the work? Answer
Choices: (a) harder (b) anguish (c) bitterness (d) tears (e) sadness
A: The answer should be the feeling of someone getting divorced who was doing all the
work. Of the above choices, the closest feeling is bitterness. So the answer is (c).

TABLE 1-6
Few-shot exemplars for full chain of thought prompt for StrategyQA.

Q: Do hamsters provide food for any animals?
A: Hamsters are prey animals. Prey are food for predators. Thus, hamsters provide food for
some animals. So the answer is yes.
Q: Could Brooke Shields succeed at University of Pennsylvania?
A: Brooke Shields went to Princeton University. Princeton University is about as
academically rigorous as the University of Pennsylvania. Thus, Brooke Shields could also
succeed at the University of Pennsylvania. So the answer is yes.
Q: Yes or no: Hydrogen's atomic number squared exceeds number of Spice Girls?
A: Hydrogen has an atomic number of 1. 1 squared is 1. There are 5 Spice Girls. Thus,
Hydrogen's atomic number squared is less than 5. So the answer is no.
Q: Yes or no: Is it common to see frost during some college commencements?
A: College commencement ceremonies can happen in December, May, and June. December
is in the winter, so there can be frost. Thus, there could be frost at some commencements. So
the answer is yes.
Q: Yes or no: Could a llama birth twice during War in Vietnam (1945-46)?
A: The War in Vietnam was 6 months. The gestation period for a llama is 11 months, which
is more than 6 months. Thus, a llama could not give birth twice during the War in Vietnam.
So
the answer is no.
Q: Yes or no: Would a pear sink in water?
A: The density of a pear is about 0.6 g = cm3, which is less than water. Objects less dense than
water float. Thus, a pear would float. So the answer is no.

TABLE 1-7
Few-shot exemplars for full chain of thought prompt for Date Understanding.

Q: 2015 is coming in 36 hours. What is the date one week from today in MM/DD/YYYY?
A: If 2015 is coming in 36 hours, then it is coming in 2 days. 2 days before 01/01/2015 is
12/30/2014, so today is 12/30/2014. So one week from today will be 01/05/2015. So the
answer is 01/05/2015.
Q: The first day of 2019 is a Tuesday, and today is the first Monday of 2019. What is the date
today in MM/DD/YYYY?
A: If the first day of 2019 was Tuesday, then 01/01/2019 was a Tuesday. Today is the first
monday, would be six days later. So today is 01/07/2019. So the answer is 01/07/2019.
Q: The concert was scheduled to be on 06/01/1943, but was delayed by one day to today.
What is the date 10 days ago in MM/DD/YYYY?
A: One day after 06/01/1943 is 06/02/1943, so today is 06/02/1943. 10 days before today is
05/23/1943. So the answer is 05/23/1943.
Q: It is 4/19/1969 today. What is the date 24 hours later in MM/DD/YYYY?
A: Today is 04/19/1969. 24 hours later is one day after today, which would be 04/20/1969.
So the answer is 04/20/1969.
Q: Jane thought today is 3/11/2002, but today is in fact Mar 12, which is 1 day later. What is
the date 24 hours later in MM/DD/YYYY?
A: Today is 03/12/2002. So the date 24 hours later will be 03/13/2002. So the answer is
03/13/2002.
Q: Jane was bom on the last day of Feburary in 2001. Today is her 16-year-old birthday.
What is the date yesterday in MM/DD/YYYY?
A: The last day of February is the 28th, so Jane was born on 02/28/2001. Today is her 16-
year old birthday, so today is 02/28/2017. So yesterday was 02/27/2017. So the answer is
02/27/2017.

TABLE 1-8
Few-shot exemplars for full chain of thought prompt for Sports Understanding.

Q: Is the following sentence plausible? “Kyle Palmieri was called for slashing.”
A: Kyle Palmieri is a hockey player. Being called for slashing is part of hockey. So the
answer is yes.
Q: Is the following sentence plausible? “Joao Moutinho caught the screen pass in the NFC
championship.”
A: Joao Moutinho is a soccer player. The NFC championship is part of American football,
not soccer. So the answer is no.
Q: Is the following sentence plausible? “Carson Wentz set the pick and roll.”
A: Carson Wentz is an American football player. Pick and roll is part of basketball, not
football. So the answer is no.
Q: Is the following sentence plausible? “Jonas Valanciunas beat the buzzer.”
A: Jonas Valanciunas is a basketball player. Beating the buzzer is part of basketball. So the
answer is yes.
Q: Is the following sentence plausible? “Jamel Murray was perfect from the line.”
A: Jamal Murray is a basketball player. Being perfect from the line is part of basketball. So
the answer is yes.
Q: Is the following sentence plausible? “Sam Darnold passed the puck.”
A: Sam Darnold is a American football player. Passing the puck is part of hockey, not
American football. So the answer is no.
Q: Is the following sentence plausible? “Draymond Green threw a touchdown.”
A: Draymond Green is an basketball player. Throwing a touchdown is part of football, not
basketball. So the answer is no.
Q: Is the following sentence plausible? “Malcolm Brogdon banked the shot in.”
A: Malcolm Brogdon is a basketball player. Banking the shot in is part of basketball. So the
answer is yes.

### Example Results: Self-Consistency

Example results for an example self-consistency technique according to the present disclosure is provided over the following reasoning benchmarks:
(1) Arithmetic reasoning: GSM8K, AddSub, MultiArith, and ASDiv from above, as well as AQUA-RAT (Ling et al., Program induction by rationale generation: Learning to solve and explain algebraic word problems, In Proceedings of the 55th Annual Meeting of the Association for Computational Linguistics (Volume 1: Long Papers), 2017. doi:10.18653/v1/P17-1015) and SVAMP (Patel et al., Are NLP models really able to solve simple math word problems?, In Proceedings of the 2021 Conference of the North American Chapter of the Association for Computational Linguistics: Human Language Technologies, pp. 2080-2094).
(2) Commonsense reasoning: CommonsenseQA and StrategyQA (Geva et al., 2021) for open-domain question-answering with implicit multi-hop reasoning, and the AI2 Reasoning Challenge (ARC) (Clark et al., Think you have solved question answering? Try arc, the AI2 reasoning challenge, ArXiv, abs/1803.05457, 2018).

Example self-consistency techniques were used to obtain results over the following dense left-to-right, decoder-only transformer language models with varying scales:
(1) LaMDA-PT from above with 137-billion parameters, pretrained on a mixture of web documents, dialog data and Wikipedia; and
(2) PaLM from above with 540-billion parameters, pretrained on a high quality corpus of 780 billion tokens with filtered webpages, books, Wikipedia, news articles, source code, and social media conversations.

For the following example results, the same set of prompts presented above are used. Sampling scheme.

To sample diverse reasoning paths, for LaMDA-137B temperature sampling was used with T=0.5 and truncated at the top-k (k=40) tokens with the highest probability, and for PaLM-540B T=0.7, k=40. Example techniques of self-consistency according to the present disclosure can be generally robust to sampling strategies and parameters. For sampled results, the results are averaged over 10 runs, where 40 outputs are sampled independently from the decoder in each run. Greedy decoding a single chain of thought (e.g., as in previous examples) is provided for comparison.

State-of-the-art results can be obtained on almost all tasks: despite the fact that self-consistency is unsupervised and task-agnostic, these results compare favorably to more costly existing approaches that require task-specific training, or fine-tuning with thousands of examples (e.g., on GSM8K). Example results are provided for arithmetic reasoning in Table 1-9. Example results on commonsense reasoning tasks are given in Table 1-10.

TABLE 1-9
Arithmetic reasoning results.

| | Method | AddSab | MultiArith | ASDiv | AQuA | SVAMP | GSM8K |
|---|---|---|---|---|---|---|---|
| | Previous SoTA | 94.9^{a} | 60.5^{a} | 75.3^{b} | 37.9^{c} | 57.4^{d} | 35^{e}/57^{g} |
| LaMDA | Greedy decode (Single-path) | 52.9 | 51.8 | 49.0 | 17.7 | 38.9 | 17.1 |
| (137B) | Self-Consistency (Multi-path) | 63.5 (+10.6) | 75.7 (+23.9) | 58.2 (+9.2) | 26.8 (+9.1) | 53.3 (+14.4) | 27.7 (+10.6) |
| PaLM | Greedy decode (Single-path) | 91.9 | 94.7 | 74.0 | 35.8 | 79.0 | 56.5 |
| (540B) | Self-Consistency (Multi-path) | 93.7 (+1.8) | 99.3 (+4.6) | 81.9 (+7.9) | 48.3 (+12.5) | 86.6 (+7.6) | 74.4 (+17.9) |

TABLE 1-10
Common Sense Reasoning Results.

| | Method | CommonsenseQA | StrategyQA | ARC (Easy) | ARC (Challenge) |
|---|---|---|---|---|---|
| | Previous SoTA | 91.2^{a} | 73.9^{b} | 86.4^{c} | 75.0^{c} |
| LaMDA | Greedy decode (Single-path) | 57.9 | 65.4 | 75.3 | 55.1 |
| (137B) | Self-Consistency (Multi-path) | 63.1 (+5.2) | 67.8 (+2.4) | 79.3 (+4.0) | 59.8 (+4.7) |
| PaLM | Greedy decode (Single-path) | 79.0 | 75.3 | 95.3 | 85.2 |
| (540B) | Self-Consistency (Multi-path) | 80.7 (+1.7) | 81.6 (+6.3) | 96.4 (+1.1) | 88.7 (+3.5) |

### Example Results: Query Recursion

Example results are provided for the last-letter concatenation task. In this example task, the query includes a list of words, and the response is the concatenation of the last letters of the words in the list. For example, “thinking, machine” outputs “ge” since the last letter of “thinking” is “g” and the last letter of “machine” is “e”. The experiment setup is as follows: (1) only two demonstration examples are provided; and (2) the lists in training contain at most three words, while the lists for testing can be arbitrarily long. Although this task is straightforward for humans, it is extremely challenging for statistical machine learning methods. First, machine learning models trained with only two examples are not expected to generalize well. Second, the length-based train and test split requires out-of-distribution generalization, which is highly non-trivial for statistical learning.

The initial instructive sequences used for the Chain of Thought example and the Query Recursion example are provided in Table 1-10. Testing lists with lengths from 4 to 12 words were sampled from Wiktionary. For each length, 500 lists are constructed. Example results are given in Table 1-11.

TABLE 1-10
Chain-of-thought and Query Recursion prompts for the example last letter concatenation
task. Prompts for the naïve baseline are simply input/output pairs.

| Chain of Thought | Query Recursion |
|---|---|
| Q: “think, machine” | Q: “think, machine” |
| A: The last letter of “think” is “k”. The last | A: The last letter of “think” is “k”. The |
| letter of “machine” is “e”. Concatenating “k”, | last letter of “machine” is “e”. |
| “e” leads to “ke”. So, “think, machine” outputs | Concatenating “k”, “e” leads to “ke”. So, |
| “ke”. | “think, machine” outputs “ke”. |
| Q: “learning, reasoning, generalization” | Q: “think, machine, learning” |
| A: The last letter of “learning” is “g”. The last | A: “think, machine” outputs “ke”. The |
| letter of “reasoning” is “g”. The last letter of | last letter of “learning” is “g”. |
| “generalization” is “n”. Concatenating “g”, | Concatenating “ke”, “g” leads to “keg”. |
| “g”, “n” leads to “ggn”. So, “learning, | So, “think, machine, learning” outputs |
| reasoning, generalization” outputs “ggn”. | “keg”. |

TABLE 1-11
Accuracy of different prompting methods with code-
davinci-002 on the last-letter-concatenation task
with the length of lists increasing from 4 to 12.

| Method | L = 4 | L = 6 | L = 8 | L = 10 | L = 12 |
|---|---|---|---|---|---|
| Naïve Prompting | 0.0 | 0.0 | 0.0 | 0.0 | 0.0 |
| Chain of Thought | 89.4 | 75.0 | 51.8 | 39.8 | 33.6 |
| Query Recursion | 94.0 | 88.4 | 83.0 | 76.4 | 74.0 |

Example results are also provided for the SCAN benchmark (Lake & Baroni, 2018). This benchmark relates to mapping natural language commands to sequences of actions. For this example, all the prompting methods share the same commands, but Naïve Prompting directly maps commands to action sequences without explanations, and Chain of Thought uses the same command-mapping prompts as Query Recursion, except without command reduction. Example results are given in Table 1-12.

TABLE 1-12
Accuracies (%) of different prompting methods on the test set
of SCAN under the length-based split. The results of text-
davinci-002 are based on a random subset of 100 commands.

| | code-davinci- | code-davinci- | text-davinci- |
|---|---|---|---|
| Method | 002 | 001 | 002 |
| Naïve Prompting | 16.7 | 0.4 | 6.0 |
| Chain of Thought | 16.2 | 0.0 | 0.0 |
| Query Recursion | 99.7 | 60.7 | 76.0 |

Example results are also provided for the DROP benchmark. This benchmark relates to reading comprehension and numerical reasoning. All prompting methods for these example results take 3 shot prompts. An example set of prompts for Query Recursion prompting is shown in Table 1-13, where the prompt on the left column shows how a problem is reduced to subproblems, and the prompt on the right column shows how the subproblems are sequentially solved. Prompts for Chain of Thought here were generated by merging Query Recursion prompts for subproblems, and prompts for Naïve Prompting were generated from the Chain of Thought prompts by removing reasoning chains. Example results are given in Table 1-14.

TABLE 1-13
Example prompts for Query Recursion Example.

| Example Query Breakdown Prompt | Example Query Recursion Prompt |
|---|---|
| Q: The gender distribution of the population | The gender distribution of the population |
| was 50.2% male and 49.8% female. Of the | was 50.2% male and 49.8% female. Of |
| adult population, 29 people or 14.6% of the | the adult population, 29 people or 14.6% |
| population are between 20 and 29 years old. 28 | of the population are between 20 and 29 |
| people or 14.1% are 30 to 39, 36 people or | years old. 28 people or 14.1% are 30 to |
| 18.2% are 40 to 49, and 31 people or 15.7% | 39, 36 people or 18.2% are 40 to 49, and |
| are 50 to 59. How many percent of people are | 31 people or 15.7% are 50 to 59. |
| not 40 to 49? | Q: How many percent of people are 40 to |
| A: To answer the question “How many percent | 49? |
| of people are not 40 to 49?’, we need to know | A: “36 people or 18.2% are 40 to 49”. So |
| “How many percent of people are 40 to 49?” | the answer is 18.2%. |
| | Q: How many percent of people are not |
| | 40 to 49? |
| | A: We know that 18.2% are 40 to 49. |
| | So 100% − 18.2% = 81.8% are not 40 to |
| | 49. So the answer is 81.8%. |

TABLE 1-14
Accuracies (%) of different prompting methods on the test set
of SCAN under the length-based split. The results of text-
davinci-002 are based on a random subset of 100 commands.

| | Non-Football (3988 cases) | | Football (1862 cases) | |
|---|---|---|---|---|
| | code-davinci- | | code-davinci- | |
| Method | 002 | PaLM | 002 | PaLM |
| Zero-shot | 43.86 | 48.42 | 51.77 | 44.95 |
| Naïve Prompting | 58.78 | 56.54 | 62.73 | 60.47 |
| Chain of Thought | 74.77 | 63.84 | 59.56 | 67.35 |
| Query Recursion | 82.45 | 79.24 | 73.42 | 69.98 |

### Example Devices and Systems

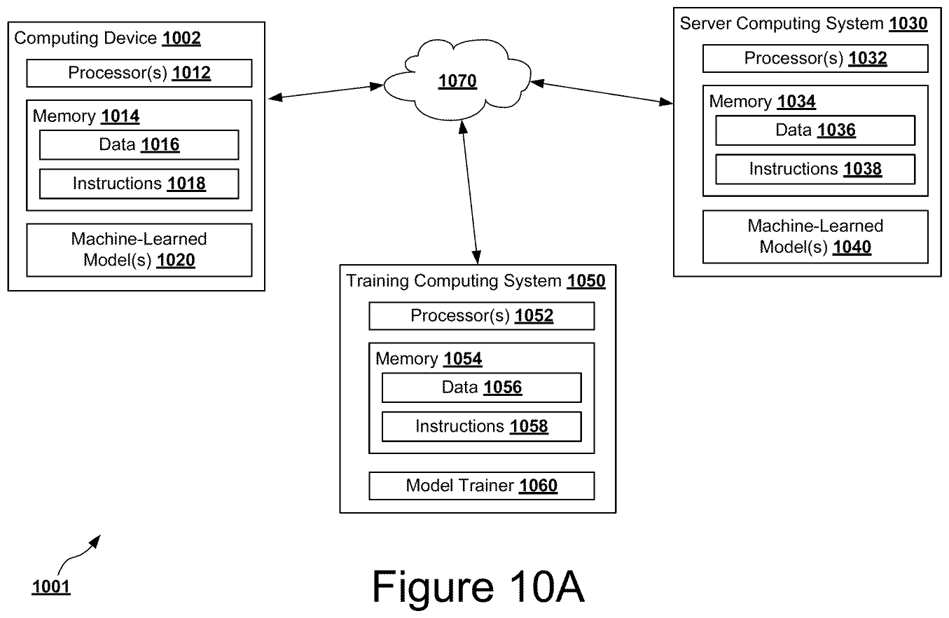

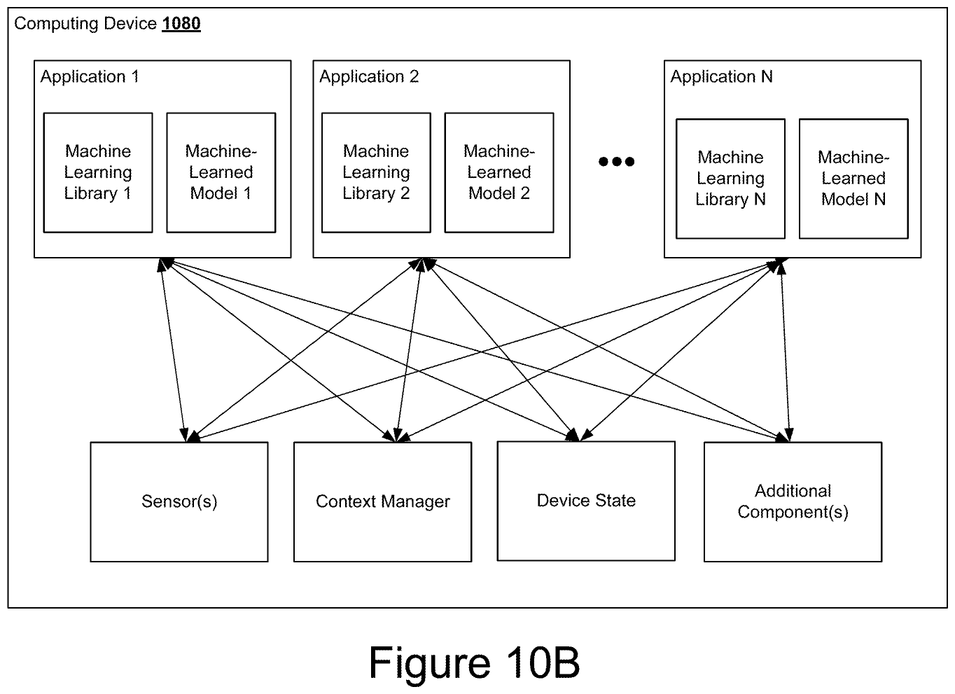

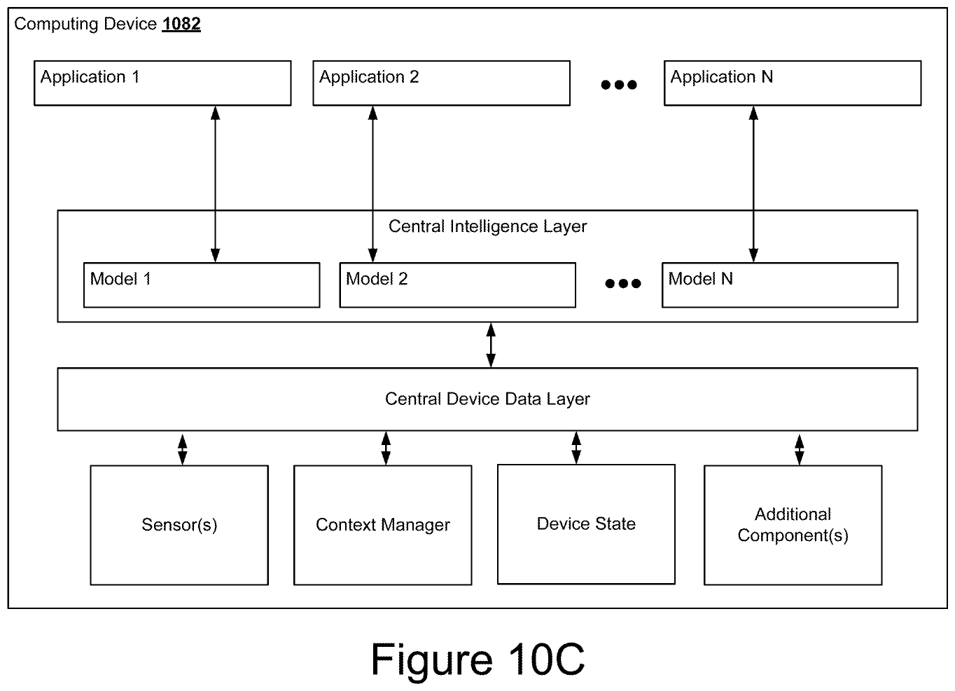

FIG. 10A depicts a block diagram of an example computing system 1001 that can generate or implement input data structures and self-consistency output sampling according to example embodiments of the present disclosure. The system 1001 includes a computing device 1002, a server computing system 1030, and a training computing system 1050 that are communicatively coupled over a network 1070.

The computing device 1002 can be any type of computing device, such as, for example, a personal computing device (e.g., laptop or desktop), a mobile computing device (e.g., smartphone or tablet), a gaming console or controller, a wearable computing device, an embedded computing device, or any other type of computing device. In some embodiments, the computing device 1002 can be a client computing device. The computing device 1002 can include one or more processors 1012 and a memory 1014. The one or more processors 1012 can be any suitable processing device (e.g., a processor core, a microprocessor, an ASIC, an FPGA, a controller, a microcontroller, etc.) and can be one processor or a plurality of processors that are operatively connected. The memory 1014 can include one or more non-transitory computer-readable storage media, such as RAM, ROM, EEPROM, EPROM, flash memory devices, magnetic disks, etc., and combinations thereof. The memory 1014 can store data 1016 and instructions 1018 which are executed by the processor 1012 to cause the user computing device 1002 to perform operations (e.g., to perform operations implementing input data structures and self-consistency output sampling according to example embodiments of the present disclosure, etc.).

In some implementations, the user computing device 1002 can store or include one or more machine-learned models 1020. For example, the machine-learned models 1020 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, one or more machine-learned models 1020 can be received from the server computing system 1030 over network 1070, stored in the computing device memory 1014, and used or otherwise implemented by the one or more processors 1012. In some implementations, the computing device 1002 can implement multiple parallel instances of a machine-learned model 1020.

Additionally, or alternatively, one or more machine-learned models 1040 can be included in or otherwise stored and implemented by the server computing system 1030 that communicates with the computing device 1002 according to a client-server relationship.

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some embodiments, the machine-learned models 1040 can be implemented by the server computing system 1040 as a portion of a web service (e.g., remote machine-learned model hosting service, such as an online interface for performing machine-learned model operations over a network on remote servers 1030). For instance, the server computing system 1030 can communicate with the computing device 1002 over a local intranet or internet connection. For instance, the computing device 1002 can be a workstation or endpoint in communication with the server computing system 1030, with implementation of the model 1040 on the server computing system 1030 being remotely performed and an output provided (e.g., cast, streamed, etc.) to the computing device 1002. Thus, one or more models 1020 can be stored and implemented at the user computing device 1002 or one or more models 1040 can be stored and implemented at the server computing system 1030.

The computing device 1002 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 1030 can include one or more processors 1032 and a memory 1034. The one or more processors 1032 can be any suitable processing device (e.g., a processor core, a microprocessor, an ASIC, an FPGA, a controller, a microcontroller, etc.) and can be one processor or a plurality of processors that are operatively connected. The memory 1034 can include one or more non-transitory computer-readable storage media, such as RAM, ROM, EEPROM, EPROM, flash memory devices, magnetic disks, etc., and combinations thereof. The memory 1034 can store data 1036 and instructions 1038 which are executed by the processor 1032 to cause the server computing system 1030 to perform operations (e.g., to perform operations implementing input data structures and self-consistency output sampling according to example embodiments of the present disclosure, etc.).

In some implementations, the server computing system 1030 includes or is otherwise implemented by one or more server computing devices. In instances in which the server computing system 1030 includes plural server computing devices, such server computing devices can operate according to sequential computing architectures, parallel computing architectures, or some combination thereof.

As described above, the server computing system 1030 can store or otherwise include one or more machine-learned models 1040. For example, the models 1040 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The computing device 1002 or the server computing system 1030 can train example embodiments of a machine-learned model (e.g., including models 1020 or 1040) using a pretraining pipeline (e.g., an unsupervised pipeline, a semi-supervised pipeline, etc.). In some embodiments, the computing device 1002 or the server computing system 1030 can train example embodiments of a machine-learned model (e.g., including models 1020 or 1040) using a pretraining pipeline by interaction with the training computing system 1050. In some embodiments, the training computing system 1050 can be communicatively coupled over the network 1070. The training computing system 1050 can be separate from the server computing system 1030 or can be a portion of the server computing system 1030.

The training computing system 1050 can include one or more processors 1052 and a memory 1054. The one or more processors 1052 can be any suitable processing device (e.g., a processor core, a microprocessor, an ASIC, an FPGA, a controller, a microcontroller, etc.) and can be one processor or a plurality of processors that are operatively connected. The memory 1054 can include one or more non-transitory computer-readable storage media, such as RAM, ROM, EEPROM, EPROM, flash memory devices, magnetic disks, etc., and combinations thereof. The memory 1054 can store data 1056 and instructions 1058 which are executed by the processor 1052 to cause the training computing system 1050 to perform operations (e.g., to perform operations implementing input data structures and self-consistency output sampling according to example embodiments of the present disclosure, etc.). In some implementations, the training computing system 1050 includes or is otherwise implemented by one or more server computing devices.

The model trainer 1060 can include a pretraining pipeline for training machine-learned models using various objectives. Parameters of the image-processing model(s) can be trained, in some embodiments, using various training or learning techniques, such as, for example, backwards propagation of errors. For example, an objective or loss can be backpropagated through the pretraining pipeline(s) to update one or more parameters of the model(s) (e.g., based on a gradient of the loss function). Various determinations of loss can be used, such as mean squared error, likelihood loss, cross entropy loss, hinge loss, or various other loss functions. Gradient descent techniques can be used to iteratively update the parameters over a number of training iterations. In some implementations, performing backwards propagation of errors can include performing truncated backpropagation through time. The pretraining pipeline can perform a number of generalization techniques (e.g., weight decays, dropouts, etc.) to improve the generalization capability of the models being trained.

The model trainer 1060 can include computer logic utilized to provide desired functionality. The model trainer 1060 can be implemented in hardware, firmware, or software controlling a general-purpose processor. For example, in some implementations, the model trainer 1060 includes program files stored on a storage device, loaded into a memory, and executed by one or more processors. In other implementations, the model trainer 1060 includes one or more sets of computer-executable instructions that are stored in a tangible computer-readable storage medium such as RAM, hard disk, or optical or magnetic media.

The network 1070 can be any type of communications network, such as a local area network (e.g., intranet), wide area network (e.g., Internet), or some combination thereof and can include any number of wired or wireless links. In general, communication over the network 1070 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 10A illustrates one example computing system that can be used to implement the present disclosure. Other computing systems can be used as well. For example, in some implementations, the computing device 1002 can include the model trainer 1060. In some implementations, the computing device 1002 can implement the model trainer 1060 to personalize the model(s) based on device-specific data.

FIG. 10B depicts a block diagram of an example computing device 1080 that performs according to example embodiments of the present disclosure. The computing device 1080 can be a user computing device or a server computing device. The computing device 1080 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 10B, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 10C depicts a block diagram of an example computing device 1082 that performs according to example embodiments of the present disclosure. The computing device 1082 can be a user computing device or a server computing device. The computing device 1082 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 10C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 1082.

The central intelligence layer can communicate with a central device data layer. The central device data layer can be a centralized repository of data for the computing device 1082. As illustrated in FIG. 10C, the central device data layer can communicate with a number of other components of the computing device, such as, for example, one or more sensors, a context manager, a device state component, or additional components. In some implementations, the central device data layer can communicate with each device component using an API (e.g., a private API).

### Example Methods

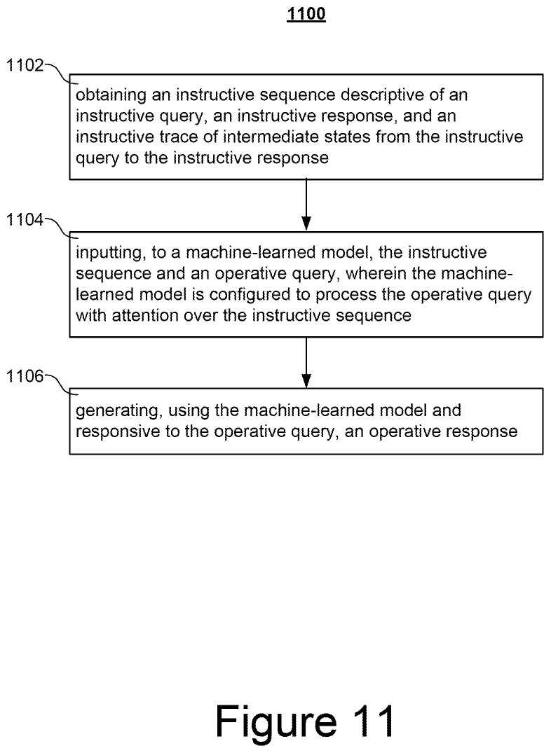

FIG. 11 depicts a flow chart diagram of an example method 1100 to perform according to example embodiments of the present disclosure. Although FIG. 11 depicts steps performed in a particular order for purposes of illustration and discussion, the methods of the present disclosure are not limited to the particularly illustrated order or arrangement. The various steps of the method 1100 can be omitted, rearranged, combined, and/or adapted in various ways without deviating from the scope of the present disclosure.

At 1102, a computing system can obtain an instructive sequence descriptive of an instructive query, an instructive response, and an instructive trace of intermediate states from the instructive query to the instructive response. For example, illustrative instructive queries, responses, and traces are discussed with respect to FIGS. 1 to 4. For instance, in some embodiments, the instructive trace can contain a chain of intermediate states or responses. For example, in some embodiments, the instructive trace can contain a chain of intermediate responses to intermediate queries (e.g., as illustrated in FIGS. 2 to 4).

In some embodiments, the instructive sequence can contain an input flag. For example, an instructive query can contain, for example, an input flag signifying a start of a query (e.g., “Q:”). In some embodiments, the instructive query can also contain an output flag. For instance, an output flag can signify an end of a query or a beginning of a portion of the sequence corresponding to a response to be generated. Example flags are shown in FIGS. 2 to 4 (e.g., “Q:”, “A:”, “Consider the following Python function”, “[BEGIN]”, etc.).

In some embodiments, the instructive sequence can include a tokenized representation of natural language (e.g., FIGS. 2, 4, etc.). For instance, the instructive sequence can be obtained by receiving a natural language sequence of words, instructions, questions, explanations, etc. and embedding the sequence into one or more tokens (e.g., word tokens, sub-word tokens, character tokens, etc.). In some embodiments, the instructive sequence can include a tokenized representation of a computer-executable coding language (e.g., FIG. 3). For instance, an instructive sequence can be provided to prompt the machine-learned model to simulate execution of a computer-executable script or program (e.g., to evaluate a final output, to evaluate one or more intermediate states of variables or parameters, etc.).

At 1104, the computing system can input to a machine-learned model, the instructive sequence and an operative query. In some embodiments, the machine-learned model is configured to process the operative query with attention over the instructive sequence. In some embodiments, the instructive sequence can be prepended to the operative query. For example, in some embodiments, the machine-learned model comprises a transformer architecture (e.g., encoder, decoder, etc.) into which the input data structure according to the present disclosure can be input.

At 1106, the computing system can generate, using the machine-learned model and responsive to the operative query, an operative response. In some embodiments, generating the operating response can include generating, using the machine-learned model, a plurality of operative responses. In some embodiments, generating the operating response can include determining the operative response based on a sample of the plurality of operative responses. In some embodiments, the sample is random. In some embodiments, the sample is based on respective probabilities associated with the plurality of operative responses.

In some embodiments, determining the operative response includes determining a consistency metric based on the sample of the plurality of operative responses. For example, a consistency metric can include a self-consistency metric configured to determine internally consistent outputs. In some embodiments, the consistency metric includes a plurality vote (e.g., a vote of output values from one or more operative responses). In some embodiments, the consistency metric includes a majority vote (e.g., a vote of output values from one or more operative responses).

In some embodiments, the method 1100 can include generating, using the machine-learned model and responsive to the operative query, an operative trace of intermediate states from the operative query to the operative response. In some embodiments, the vote (e.g., plurality vote, majority vote, etc.) can be based on a plurality of operative responses respectively associated with a plurality of diverse operative traces.

In some embodiments, the operative query can be a first query component and the operative response can be a first response component, and the method 1100 can include inputting, to the machine-learned model, the instructive sequence, the first query component, the first response component, and a second query component. For instance, the method 1100 can include a query recursion process flow (e.g., as described above with respect to FIG. 5).

For instance, in some embodiments, the method 1100 can include generating using the machine-learned model and responsive to the second query component, a second response component.

For instance, in some embodiments, the method 1100 can include generating, by the computing system and responsive to a target query, one or more query components.

For instance, in some embodiments, the method 1100 can include inputting, to the machine-learned model, a preliminary instructive sequence including a preliminary instructive query and a preliminary instructive response. In some embodiments, the preliminary instructive response includes a plurality of preliminary instructive query components.

For instance, in some embodiments, the method 1100 can include a first query component and a second query component that are generated with a different machine-learned model other than the machine-learned model used to obtain the first response component and the second response component.

For instance, in some embodiments, the method 1100 can include a second query component corresponding to the target query.

For instance, in some embodiments, the method 1100 can include, for a plurality of iterations, one or more generating and inputting operations that build on one another. For instance, in some embodiments, the method 1100 can include, for a plurality of iterations, generating an updated instructive sequence based on combining one or more prior input sequences with one or more output sequences respectively corresponding thereto; inputting, to the machine-learned model, the updated instructive sequence and an additional query component; and generating, using the machine-learned model and responsive to the additional query component, an additional response component.

### Example Pretraining Pipeline Arrangements

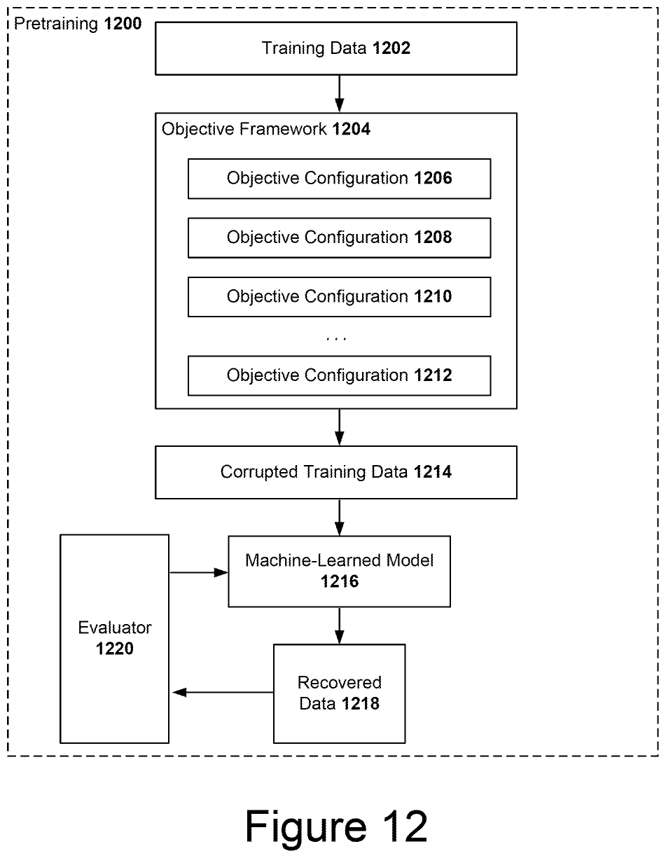

FIG. 12 depicts a block diagram of an example pretraining pipeline 1200. The pretraining pipeline 1200 can be configured to process training data 1202 using an objective framework 1204. The objective framework 1204 can provide for a plurality of configurations (e.g., objective configurations 1206, 1208, 1210, 1212, etc.). Based on the plurality of objective configurations, corrupted training data 1214 can be obtained for input to a machine-learned model 1216 as a training example. The machine-learned model 1216 can generate recovered data 1218 and evaluator 1220 can evaluate the performance of the machine-learned model 1216 in recovering the corrupted training data 1214. Based on the evaluated performance, one or more parameters of the machine-learned model 1216 can be updated. In this manner, for instance, the machine-learned model 1216 can be trained, such as in a pre-training iteration prior to subsequent fine-tuning training iterations.

In general, corrupted training data 1214 can include both corrupted and uncorrupted aspects of the training data 1202. In this manner, for instance, one or more pretraining objective(s) can include attempting to recover and/or reconstruct corrupted aspects of the training data 1202, providing for an unsupervised training objective.

The machine-learned model 1216 can be provided with the corrupted training data 1214 to obtain as an output recovered data 1218. The output recovered data 1218 can be evaluated by evaluator 1220 to determine one or more updates to the machine-learned model 1216 (e.g., updates to one or more parameters of the machine-learned model 1216).

In some embodiments, training examples of the training data 1202 can include sequences of data elements (which can optionally be tokenized, such as for processing by, e.g., an encoder and/or decoder of a transformer model). In some embodiments, training examples can be subdivided into one or more subportions for generating corrupted training examples.

For example, in some embodiments, a plurality of corrupted training examples (e.g., for corrupted training data 1214) can be generated from one or more training examples (e.g., of training data 1202). In some embodiments, each training example of the one or more training examples includes a sequence of data tokens. In some embodiments, the plurality of corrupted training examples are respectively generated according to a plurality of configurations (e.g., objective configurations 1206, 1208, 1210, 1212, etc.) of a pretraining objective framework (e.g., objective framework 1204). In some embodiments, the plurality of corrupted training examples each include one or more corrupted subportions of a sequence of data tokens.

In some embodiments, the plurality of configurations can effectively interpolate between long-range generative language modeling objectives and local prefix-based modeling objectives. Advantageously, each of the plurality of object configurations can test the performance of the model 1216 in different ways. For example, bounding a model by bidirectional context (or the future) (e.g., span corruption) can make the task easier and can become more akin to fact completion. Meanwhile, language modeling objectives can be more open ended. This behaviors can be observed, for example, by monitoring cross entropy losses of different objective configurations.

In some embodiments, a modal token can be added to the input to the machine-learned model 1216 to signal the mode or paradigm of pretraining. For instance, it can be beneficial for the model 1216 to not only distinguish between different objective configurations during pre-training but also to adaptively switch modes when learning downstream tasks. Modal tokens can advantageously facilitate mode switching. Mode switching can include associating pre-training tasks with dedicated sentinel tokens and can allow dynamic mode switching via discrete prompting.

The objective framework 1204 can provide for selection from the plurality of objective configurations based on one or more parameter values. One parameter value can include a span length parameter. The span length parameter can be a mean span length parameter. For instance, a span length for a given corrupted training example can be sampled from a desired distribution (e.g., a normal distribution) with a mean set by the span length parameter. For sequence-based objectives, the span length parameter can be augmented be constraining the span to the end of the input sequence, such that no uncorrupted tokens appear after the corrupted span.

One parameter value can include a corruption rate. A corruption rate can indicate a probability of subportions of a span being corrupted. For instance, a corruption rate can be expressed as a percentage, fraction, etc.

One parameter value can include a quantity of spans. The quantity of spans can be a function of the length of the original input. The quantity of spans can be a function of the span length or mean span length. For instance, the quantity of spans can be determined based on computing the result of the input length divided by the span length.

Parameterizing the objective framework based on the span length, corruption rate, and quantity of spans can provide for multiple different objective configurations that can interpolate among different types of learning objectives. As an example, to construct an objective analogous to causal language modeling using this formulation, one could set the span length to the length of the input span, a corruption rate of 100%, and the quantity of spans to 1 (e.g., a single corrupted span with its span length equal to the length of the input sequence). To express one similar to prefix-based language modeling objective, one could set the span length to the difference between the input sequence length and a prefix length and the quantity of spans to a single, post-prefix span, with the additional constraint that the single corrupted span reaches the end of the sequence. The corruption rate can be set at, for example 100% minus the ratio of the prefix length to the input span length.

Multiple different objective configurations can be used. For instance, a first objective configuration can be used for training example. A second objective configuration can be used for a second training example. A third objective configuration can be used for a third training example. Alternatively, multiple different objective configurations can be used for each training example.

An example mixture of objective configurations is described herein with respect to three different types or classes of configurations. The first two types or classes of configurations that follow can be considered distributed configurations, in that they can be configured for generating multiple corrupted spans distributed across the input sequence (e.g., randomly distributed). The third type or class can be considered a sequential configuration, in that it can be configured for generating a corrupted span in a particular sequence (e.g., a sequence of uncorrupted input followed by a single span of corrupted input).

A first objective configuration can be a configuration that implements relatively short corrupted spans. The first objective configuration can include relatively short corrupted spans with relatively low corruption rates. The first objective configuration can be similar to “regular” span corruption objectives, such as introduced by Colin Raffel, Noam Shazeer, Adam Roberts, Katherine Lee, Sharan Narang, Michael Matena, Yanqi Zhou, Wei Li, & Peter J Liu, Exploring the limits of transfer learning with a unified text-to-text transformer, arXiv preprint arXiv:1910.10683, 2019. An example first objective configuration can include parameters to use about 2 to 5 tokens as the span length, or less than about 10 tokens, and corrupting about 15% of input tokens. A first objective configuration can be a mild corruption configuration.

A second objective configuration can be a configuration that implements more extreme corruption. The second objective configuration can include longer spans for corruption. The second objective configuration can include higher corruption rates. For instance, an example second objective configuration can include spans for corruption of length greater than about 12 tokens. In some examples, approximately half the input can be portioned apart for corruption. An example second objective configuration can include a corruption rate of greater than about 30%, such as about 50% or greater.

A third objective configuration can be a configuration that implements relatively long-form language generation. The third objective configuration can be a sequence-based objective. The third objective configuration can be set up to provide for a predetermined sequential ordering of uncorrupted and corrupted spans. For instance, the third objective configuration can provide a prefix-based language modeling task. The third objective configuration can partition the input sequence into two sub-sequences of tokens as context and target such that the targets do not rely on future information.

A pretraining pipeline 1200 can leverage any one or more of objective configurations from the three different classes. A pretraining pipeline 1200 can implement all three classes of objective configurations. A pretraining pipeline 1200 can implement one or more objective configurations from each of the three classes. For instance, multiple sets of configuration parameters can be used within each class. For instance, the mild class of objectives can be implemented with a span length of three and a span length of 8 together (e.g., in parallel), both with a corruption rate of 15%. The more extreme class of objectives can be implemented with a span length of three, a span length of 8, a span length of 64 (all with a corruption rate of 50%) and a span length of 64 with a corruption rate of 15%. The sequence-based class of objectives can be configured with a variety of span lengths, such as one-quarter of the input sequence length, with a corruption rate of 25%. In this manner, for instance, each class can be implemented in different configurations in parallel to train model 1216. For instance, all seven of the examples provided above can be used during training of model 1216.

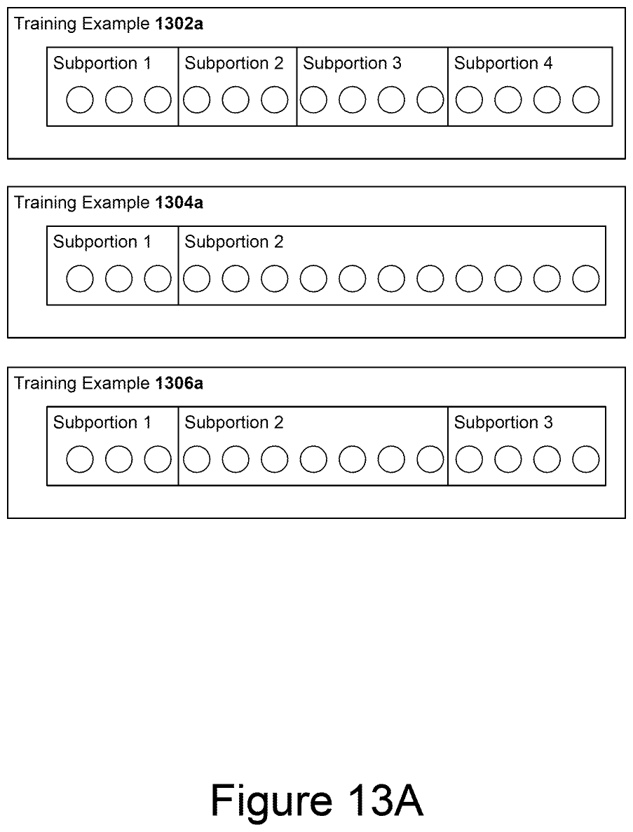

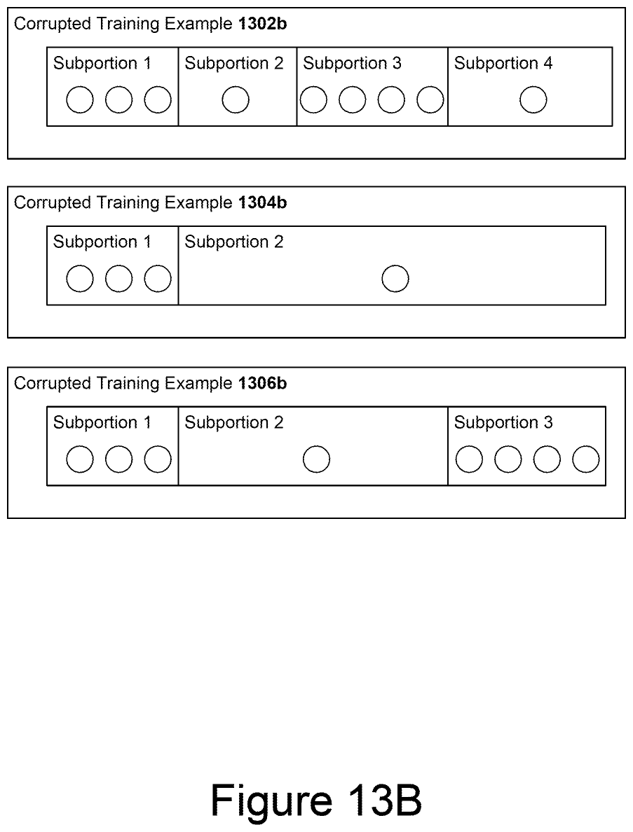

In FIG. 13A, a block diagram of training examples 1302a, 1304a, and 1306a illustrates a plurality of training examples subdivided into subportions. The subportions each contain one or more data elements (e.g., tokens). According to the plurality of configurations (e.g., objective configurations 1206, 1208, 1210, 1212, etc.), one or more subportions of the training examples 1302a, 1304a, 1306a, can be selected for corruption. For instance, the training examples can be subdivided based on a configuration parameter of the objective framework characterizing a count of subportions and/or characterizing a span length of subportions (e.g., a quantity of tokens/elements for a subportion). Once one or more subportions are selected for corruption, a corruption rate configuration parameter can characterize a likelihood of the subportion being corrupted.

FIG. 13B depicts a plurality of corrupted training examples 1302b, 1304b, 1306b. The corrupted training examples 1302b, 1304b, and 1306b can be derived from the same or different uncorrupted training examples from the training data 1202 (e.g., optionally corresponding to training examples 1302a, 1304a, 1306a). Each of the corrupted training examples 1302b, 1304b, and 1306b can include one or more selected subportions for corruption. In some embodiments, at least one subportion of each of the corrupted training examples 1302, 1304, and 1306 can be corrupted. For instance, subportions 2 and 4 of corrupted training example 1302 might be corrupted (although other subportions can also be corrupted in addition to or instead of subportions 2 and 4). For instance, subportion 2 of corrupted training example 1304 might be corrupted (although other subportions can also be corrupted in addition to or instead of subportion 2). For instance, subportion 2 of corrupted training example 1306 might be corrupted (although other subportions can also be corrupted in addition to or instead of subportion 2). As illustrated, in some embodiments, a corrupted subportion can be replaced with a corrupted token (e.g., optionally a distinct token for each corrupted subportion).

In this manner, for example, the machine-learned model 1216 can learn to recover the corrupted subportions by processing the corrupted subportions (e.g., processing replacement or altered token(s) for the subportion).

Corrupted training examples 1302, 1304, and 1306 can be corrupted according to the same objective configuration. Each of corrupted training examples 1302, 1304, and 1306 can be corrupted according to different objective configurations. Each of corrupted training examples 1302, 1304, and 1306 can be corrupted according to a battery of objective configurations, such as each of a set of configurations.

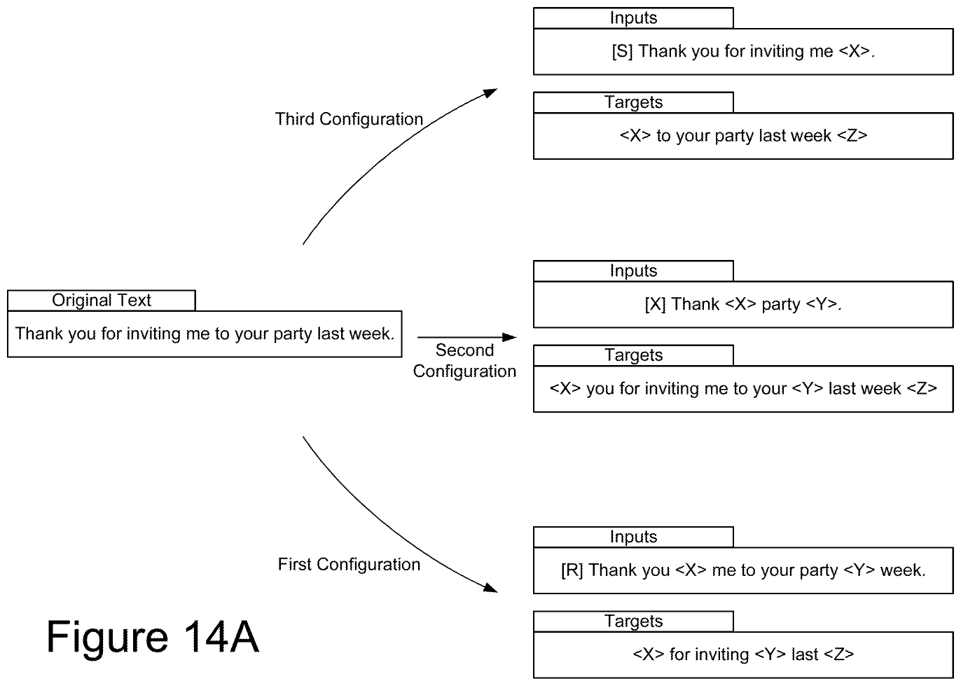

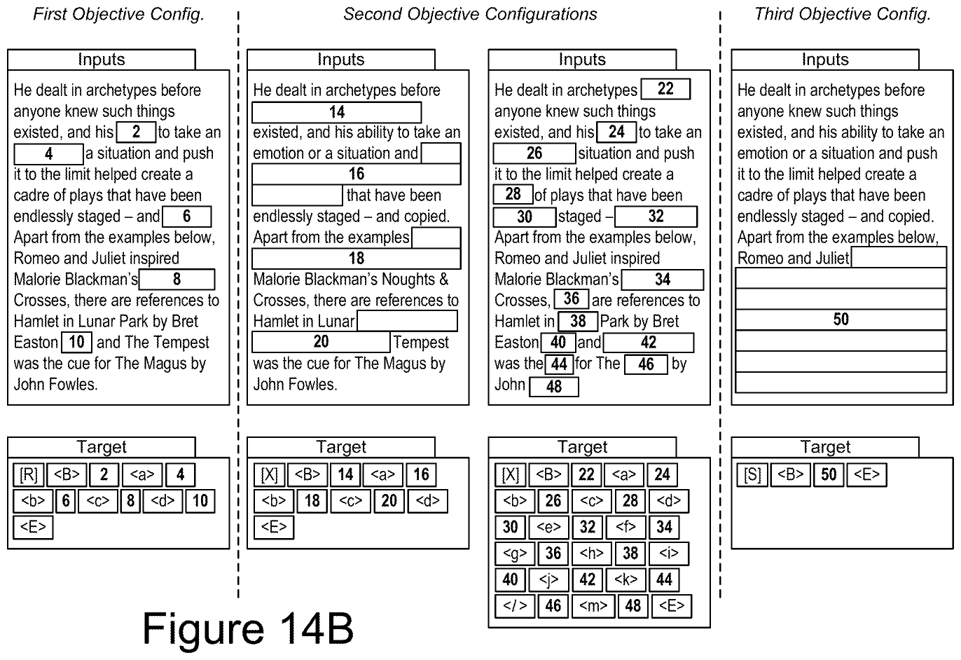

FIG. 14A depicts one illustration of how a training example can be broken out into a plurality of corrupted training examples based on a plurality of configurations of an objective framework.

Under a first objective configuration, for instance, original text “Thank you for inviting me to your party last week” can be corrupted as “Thank you <X> me to your party <Y> week” where <X> and <Y> are optionally distinct replacement tokens, such that the machine-learned model can target obtaining “for inviting” for <X> and “last” for <Y>. This can be can example of a mild objective configuration.

In a second, more extreme objective configuration, for instance, the original text can be corrupted as “Thank <X> party <Y>” where <X> and <Y> are optionally distinct replacement tokens, such that the machine-learned model can target obtaining “you for inviting me to your” for <X> and “last week” for <Y>.

In a third objective configuration, the original text can be corrupted as “Thank you for inviting me <X>.” where <X> is a replacement token, such that the machine-learned model can target obtaining “to your party last week” for <X>. This can be an example of a prefix-based language modeling objective.

In some embodiments, configuration parameters of the objective framework can be selected to interpolate between, for example, language modeling objectives (e.g., to unidirectionally predict subsequent word(s) based on preceding word(s)) and in-place reconstruction (e.g., fill in gaps bidirectionally based on surrounding context). For instance, as the corrupted subportion length increases, the objective can, in some embodiments, approximate a language modeling objective locally within the corrupted subportion. Accordingly, a diverse mixture of pretraining objectives can be generated by implementing a plurality of configurations of a pretraining objective framework according to example aspects of the present disclosure.

In some embodiments, a modal token can be added to the input to the machine-learned model 1216 to signal the mode or paradigm of pretraining. For instance, in FIG. 14A, “[R]” can indicate a modal token indicating a “regular” or “mild” class objective. “[X]” can indicate a modal token indicating a more extreme class objective. “[S]” can indicate a modal token indicating a sequence-based language modeling objective. The modal tokens can be used during pretraining, during fine-tuning, and during downstream tasks. In this manner, for instance, “mode-switching” can be invoked at inference time to engage a relevant operational mode of the trained model.

FIG. 14B illustrates an example application of a mixture of objective configurations to the same input sequence. For a first objective configuration, relatively few subportions 2, 4, 6, 8, and 10 are selected for corruption. As shown in FIG. 14B, the target for prediction by model 1216 is initiated with the modal token “[R]” indicating a regular or more mild class of objective configuration. For instance, the mean span length of the subportions 2, 4, 6, 8, and 10 can be, for instance, around 5. Sampled span lengths can be, in one example, 3, 5, 4, 5, and 2, respectively.

The symbols “<{letter}>” can be all the same or individually selected (e.g., individually different) and can be used to index the subportions 2, 4, 6, 8, and 10. For instance, the target can be input to the model 1216 (e.g., to a decoder component of the model) to trigger prediction of the original tokens corresponding to the corrupted spans indicated in the target. For instance, a placeholder token “<a>” can be associated (e.g., distinctly associated) with subportion 4. The input can include a placeholder token corresponding to “<a>” in lieu of the subportion 4. Thus the model 1216 can be configured to predict based on processing “<a>” that subportion 4 follows. Accordingly, the target can be used to guide the model 1216 toward predicting an output sequence that contains the corrupted subportions delimited by the corresponding placeholder token(s). For instance, for the first objective configuration, an example output can be “<B> ability <a> emotion or <b> copied. <c> Noughts & <d> Ellis, <E>.” In this manner, for instance, example implementations can effectively provide a fill-in-the-blank solution to masked-out subportions of the input sequence.

For a second objective configuration, multiple sets of configuration parameters can be used. For instance, in a first set of configuration parameters (left column), the mean span length can be longer (e.g., 20 tokens, 30 tokens, 40 tokens, etc.). The span quantity can be relatively low. For instance, spans 14, 16, 18, and 20 can be selected for corruption. Individual sampled span lengths can be, in one example, 16, 32, 24, and 24, respectively. In a second set of configuration parameters (right column), the mean span length can be shorter (e.g., 3 tokens, 5 tokens, 8 tokens, etc.). The span quantity can be relatively higher. For instance, spans 22, 24, 26, 28, 30, 32, 34, 36, 38, 40, 42, 44, 46, and 48 can be selected for corruption. Individual sampled span lengths can be, in one example, 3, 3, 5, 4, 4, 5, 5, 3, 3, 2, 4, 4, 2, 4, and 5, respectively. As shown in FIG. 14B, the target for this example configuration is initiated with the modal token “[X]” indicating a more extreme class of objective configuration.

For a third objective configuration, a sequence-based objective can be used. A single, longer span 50 can be selected for corruption. For instance, the span length can be 95. The span can be anchored to the end of the input sequence. As shown in FIG. 14B, the target for this example configuration is initiated with the modal token “[S]” indicating a sequence-based class of objective configuration.

### Example Results

For pre-training objectives, a Present Example is compared with the following pre-training baselines:

Causal Language Model (CLM)—This is the standard left-to-right auto-regressive language model pre-training, used in many standard pre-trained models, like GPT (Radford et al., 2019; Brown et al., 2020). This disclosure refers to this model as GPT-like in the experiments.

Prefix LM (PLM)—This is a slight variation of causal LM where M has bidirectional receptive fields, introduced in (Liu et al., 2018; Raffel et al., 2019). For this baseline, PLM is uniformly sampled for the length of M and only compute the loss at the auto-regressive targets.

Span Corruption (SC)—This is the standard denoising objective proposed in T5 (Raffel et al., 2019). The idea is to blank out certain text portions and replace them with sentinel tokens. The text replaced with sentinel tokens are then copied to the targets and autoregressively generated by the model. This baseline uses a mean span of 3 and denoising rate of 15% following the default T5 setup.

Span Corruption+LM (SCLM)—This baseline trains on a mixture of CLM and Span Corruption with an equal mix ratio. This baseline uses the same hyper-parameters for SC for the SC component of this objective.

UniLM (ULM)—This is the objective proposed in Dong et al. (2019).

For all objectives, these results explore both single-stack and encoder-decoder architectures. All architectures are inputs-to-targets either implemented in encoder-decoder or decoder-only model structures since we consider BERT-style masked language modeling pretraining to have already been effectively subsumed by this style of pretraining, as empirically made evident in (Raffel et al., 2019).

The datasets used are SuperGLUE (Wang et al., 2019), including 8 NLU subtasks. Experiments also cover 3 datasets from the GEM benchmark (Gehrmann et al., 2021) that focuses on language generation problems. XSUM (summarization), ToTTo (table-to-text generation) (Parikh et al., 2020) and Schema Guided Dialog (SGD) (Rastogi et al., 2019) from the GEM benchmark are used. For all these tasks, these results evaluate on both supervised fine-tuning and prompt-based one-shot learning. Finally these results also compare the models on their general ability for text generation using perplexity scores on the C4 validation set.

For SuperGLUE, these results report well-established metrics such as accuracy, F1 or Exact Match, whenever appropriate. For GEM benchmark, these results use the Rouge-L metric. For language modeling these results report negative log perplexity. The universality of the models, i.e., their collective performance across all range of tasks, is a main evaluation criteria here. To enable the comparison between models from this perspective, these results use an aggregate performance score. However, metrics on different tasks can be widely different in nature—take, for example, F1 and perplexity. To address this, these results opt to report and use the normalized relative gain with respect to baselines as an overall metric. For this purpose, these results use the standard language model (decoder-only) (GPT-like) and standard span denoising encoder-decoder (T5) as prime baselines and report all methods against their relative performance against these well-established candidates. The overall gain is normalized for these results, so this becomes harder to exploit or be susceptible to benchmark lottery effects.

The present experiments are all conducted in JAX/Flax (Bradbury et al., 2018) using the open source T5X4 framework (Roberts et al., 2022) and Flaxformer. The present experiments pre-train all models for 500K steps with a batch size of 128 and a sequence length of 512 inputs and 512 targets using the C4 corpus. The total approximate tokens seen during pre-training is approximately 32 billion tokens. Each pre-training run is typically trained using 64 to 128 TPUv4 chips (Jouppi et al., 2020).

The present experiments optimize the Present Example with the Adafactor (Shazeer & Stern, 2018) optimizer with an inverse square root learning rate. The present example runs all baseline pre-training objectives with both the decoder-only architecture and encoder-decoder architecture. The present results report key experiment results using a base architecture of approximately 167M parameters for the decoder model and 335M parameters for the encoder-decoder model. All models use a standard Transformer that uses SwiGLU layers as described in (Shazeer, 2020).

The present examples use the default T5 English 32K sentencepiece for all models. Within the context of decoder-only models, except for the case of the decoder model trained on causal LM, the present experiments use a bidirectional receptive field only in its input segment and autoregressive decoding at the targets segment.

Table 2-1 reports the raw results on all the benchmark tasks and datasets. The Present Example is denoted by “UL2.” To facilitate easier comparison across setups, the present results also report relative comparisons against well-established baselines such as T5 and GPT models. This is reported in Tables 2 and 3 respectively.

TABLE 2-1
Example results. All models trained on 32B parameters.

| | | | Supervised Finetuning | | | | In-context One-shot | | | | |
|---|---|---|---|---|---|---|---|---|---|---|---|
| Obj | Arch | Params | SG | XS | SGD | TOT | SG | XS | SGD | TOT | LM |
| CLM | Dec | 167M | 62.24 | 28.18 | 55.44 | 59.40 | 39.22 | 1.16 | 1.40 | 0.20 | −2.35 |
| PLM | Dec | 167M | 62.44 | 28.21 | 55.55 | 59.52 | 42.54 | 1.08 | 3.70 | 6.40 | −2.54 |
| SC | Dec | 167M | 67.67 | 29.14 | 55.48 | 60.47 | 38.53 | 1.16 | 2.20 | 1.60 | −3.62 |
| SCLM | Dec | 167M | 63.36 | 29.02 | 55.71 | 60.00 | 40.78 | 3.03 | 1.27 | 0.10 | −2.38 |
| UL2 | Dec | 167M | 65.50 | 28.90 | 55.80 | 60.39 | 42.30 | 8.01 | 6.30 | 5.80 | −2.34 |
| PLM | ED | 335M | 69.30 | 31.95 | 55.70 | 60.91 | 38.18 | 6.50 | 7.11 | 3.90 | −2.42 |
| SC | ED | 335M | 72.00 | 31.05 | 55.80 | 61.25 | 38.51 | 7.49 | 1.43 | 2.10 | −7.23 |
| SCLM | ED | 335M | 72.50 | 31.69 | 55.70 | 60.94 | 39.74 | 5.13 | 8.70 | 7.30 | −2.40 |
| UniLM | ED | 335M | 71.10 | 31.00 | 55.83 | 61.03 | 39.86 | 6.70 | 6.50 | 4.10 | −2.65 |
| UL2 | ED | 335M | 73.10 | 31.86 | 56.10 | 61.50 | 41.30 | 11.51 | 6.63 | 6.50 | −2.55 |

TABLE 2-2
Results in this table are expressed in terms of relative percentage improvements
over a baseline. Model with star denotes the main compared baseline. Overall
score column is normalized to be weighted equally across tasks.

| | | | Supervised | | | | One-shot | | | | | |
|---|---|---|---|---|---|---|---|---|---|---|---|---|
| Obj | Arch | SG | XS | SGD | TOT | SGL | XS | SGD | TOT | LM | All | Win |
| CLM | Dec | −13.6 | −9.2 | −0.7 | −3.0 | +1.8 | −91.7 | −2.2 | −90.5 | +208 | −31.7 | 2/9 |
| PLM | Dec | −13.3 | −9.2 | −0.5 | −2.8 | +10.5 | −85.6 | +158 | +205 | +185 | −11.0 | 4/9 |
| SC | Dec | −5.6 | −6.2 | −0.6 | −1.3 | +0.05 | −84.5 | +54 | −23.8 | +99 | −20.6 | 3/9 |
| SCLM | Dec | −6.0 | −6.5 | −0.2 | −2.0 | +5.9 | −59.6 | −11.3 | −95 | +204 | −16.1 | 2/9 |
| UniLM | Dec | −10.1 | −8.2 | −0.2 | −2.3 | −5.3 | −69.1 | +382 | +110 | +200 | −16.1 | 3/9 |
| UL2 | Dec | −9.0 | −6.9 | 0.0 | −1.4 | +9.8 | +6.9 | +340 | +176 | +209 | +14.1 | 5/9 |
| PLM | ED | −3.7 | +2.9 | −0.2 | −0.6 | −0.86 | −13.3 | +397 | +86 | +199 | +16.7 | 5/9 |
| SC | ED | 0.0 | 0.0 | 0.0 | 0.0 | 0.0 | 0.0 | 0.0 | 0.0 | 0.0 | 0.0 | — |
| SCLM | ED | +0.7 | +2.1 | −0.2 | −0.5 | +3.2 | −31.6 | +508 | +248 | +201 | +28.3 | 7/9 |
| UniLM | ED | −1.2 | −0.2 | +0.1 | −0.4 | +3.5 | −11.0 | +355 | +95 | +173 | +19.8 | 5/9 |
| UL2 | ED | +1.5 | +2.6 | +0.5 | +0.4 | +7.2 | +53.6 | +363 | +210 | +184 | +43.6 | 9/9 |

TABLE 2-3
Relative performance compared to standard decoder causal language model (GPT-
like). Results in this table are expressed in terms of relative percentage
improvements over a baseline. Model with star denotes the main compared baseline.
Overall score column is normalized to be weighted equally across tasks.

| | | Supervised | | | | | One-shot | | | | | |
|---|---|---|---|---|---|---|---|---|---|---|---|---|
| Obj | Arch | SG | XS | SGD | TOT | SG | XS | SGD | TOT | LM | All | Win |
| CLM* | Dec | 0.0 | 0.0 | 0.0 | 0.0 | 0.0 | 0.0 | 0.0 | 0.0 | 0.0 | 0.0 | — |
| PLM | Dec | +0.3 | +0.1 | +0.2 | +0.2 | +8.5 | +74.3 | +164 | +3100 | −8.0 | +21.4 | 8/9 |
| UniLM | Dec | +4.0 | +1.1 | +0.5 | +0.7 | −7.0 | +274 | +393 | +2100 | −2.5 | +21.0 | 7/9 |
| SC | Dec | +8.7 | +3.4 | +0.1 | +1.8 | −1.8 | +87.0 | +57.1 | +700 | −54.2 | +13.9 | 7/9 |
| SCLM | Dec | +1.8 | +3.0 | +0.5 | +1.0 | +4.0 | +387 | −9.3 | −50 | −1.3 | +15.8 | 6/9 |
| UL2 | Dec | +5.2 | +2.6 | +0.6 | +1.7 | +7.9 | +1190 | +350 | +2800 | +0.3 | +45.7 | 9/9 |
| PLM | ED | +11.3 | +13.4 | +0.5 | +2.5 | −2.6 | +946 | +408 | +1850 | −2.9 | +48.6 | 7/9 |
| SC | ED | +16.5 | +10.2 | +0.6 | +3.1 | −1.8 | +1107 | +2.3 | +950 | −208 | +31.7 | 7/9 |
| SCLM | ED | +15.7 | +12.5 | +0.5 | +2.6 | +1.3 | +726 | +522 | +3550 | −2.2 | +60.3 | 8/9 |
| UniLM | ED | +14.2 | +10.0 | +0.7 | +2.7 | +1.6 | +974 | +365 | +1950 | −12.9 | +52.6 | 8/9 |
| UL2 | ED | +17.4 | +13.1 | +1.2 | +3.5 | +5.3 | +1754 | +373 | +3150 | −8.3 | +76.1 | 8/9 |

When using T5 as the reference baseline, with the exception of UL2 Decoder, none of the pre-trained decoders models outperform T5. Additionally, there is a 10% to 30% degradation in overall relative performance. The Prefix-LM decoder model is about 10% worse than the T5 baseline. The UL2 decoder outperforms the T5 encoder-decoder setup by +14.6%.

Overall, UL2 outperforms by T5+43.4% and +76.2% when compared to the GPT-like CLM decoder model. This is the highest relative (overall) gain compared to all other alternatives. On all individual tasks, UL2 outperforms T5 on all 9 out of 9 considered tasks. Hence, UL2 is a universally better option compared to the span corruption T5 model. UL2 is very consistent. Even when it loses to another method on a task, the loss is relatively marginal (e.g., 6.5 vs 7.3 on one-shot TOTTO). Conversely, when UL2 outperforms a baseline like T5, the gain can be as large as +363%. UL2 remains the most consistently strong method. The consistent improvement also suggests that it can be used as a more consistent replacement to T5 and GPT-like models.

In order to ascertain that mode switching capabilities can be effective on performance, ablation results are provided. Experiments on one-shot XSum and one-shot SuperGLUE were conducted. Table 2-4 reports the results of varying the paradigm prompt to the model. The results show that using the right or wrong prompt can lead to a 48% gap in performance (on XSum, Rouge-1). SuperGLUE, on the other hand, was less sensitive to prompting. On SuperGLUE, using prompts was almost always better than not using prompts during one-shot evaluation.

TABLE 2-4
Effect of different paradigm prompts on 1-shot evaluation, using a
Encoder-Decoder architecture pre-trained using UL2 on 7B tokens.

| Model/Prompt | 1Shot XSum | 1Shot SuperGLUE |
|---|---|---|
| Baseline T5 | 6.9/0.6/6.1 | 33.9 |
| UL2/None | 13.2/1.4/10.8 | 38.3 |
| UL2/[R] | 13.5/1.5/11.1 | 38.5 |
| UL2/[S] | 11.6/1.2/10.0 | 38.5 |
| UL2/[X] | 8.9/0.9/7.6 | 38.7 |

TABLE 2-5
Ablation study. Span, Rate and SD are in percentages
(%). SuperGLUE score (SG) and XSUM Rouge-L (XS).

| | Ablation Method | | | Supervised | | One-shot | |
|---|---|---|---|---|---|---|---|
| Name | Span (μ) | Rate (τ) | SD % | SG | XS | SG | XS |
| A | — | — | 100 | 69.3 | 31.1 | 38.2 | 6.5 |
| B | 3 | 50 | 0 | 72.0 | 32.0 | 38.5 | 7.5 |
| C | 3, 8, 12 | 15, 50 | 14 | 71.9 | 32.1 | 38.6 | 4.1 |
| D | 3, 8, 12, 32 | 15, 50 | 11 | 71.0 | 32.2 | 42.7 | 10.6 |
| E | 3, 8, 32, 64 | 15, 50 | 11 | 73.1 | 32.2 | 40.7 | 10.4 |
| F | 3, 8, 64 | 15, 50 | 17 | 70.6 | 31.6 | 41.3 | 11.5 |
| G | 3, 8, 32, 64 | 15 | 25 | 69.2 | 31.6 | 42.4 | 10.1 |
| H | 8, 64 | 15 | 25 | 72.5 | 31.2 | 39.2 | 10.9 |
| I | 3, 8, 12, 32 | 15, 50 | 50 | 71.2 | 32.0 | 38.1 | 11.7 |
| J | 3, 8, 64 | 15, 50 | 50 | 71.3 | 31.6 | 38.1 | 11.8 |
| K | 3, 8, 12 | 15, 50 | 0 | 73.7 | 32.0 | 39.3 | 2.6 |
| L | 3, 8, 64 | 15, 50 | 0 | 70.1 | 32.1 | 38.0 | 7.3 |

Experiments are provided to test the effectiveness of individual objectives within the objective framework. Table 2-5 reports results for these ablations. Table 2-5 reports results for varying the mean span, and corruption rate, along with the percentage of S-denoising used (denoted by % SD)). For this test, the total number of configurations in a mixture was span×corruption rate+1. Table 2-5 labels these configurations from Var-A through Var-L to refer to them easily.

Additional experiments are conducted by scaling up both 1) the model size and 2) pre-training dataset size. The UL2 Encoder-Decoder model was scaled up to approximately 1B parameters and increased the number of pre-training tokens to 0.5 trillion tokens.

Table 2-6 reports results in this scaled setting. At large scale, the Present Example UL2 encoder-decoder model is still competitive. A difference now is that UL2 drops the SuperGLUE suite against T5 (1B). However, this is compensated by not only out-performing on 7 out of 8 tasks but also improving performance by 2-4 times on one-shot evaluation. The gains on supervised fine-tuning are smaller, but still noticeable across the board on XSUM, SGD and TOT.

TABLE 2-6
Experiments with moderately scaled up models in terms of model compute (e.g.,
1B for EncDec and 0.5B for decoder-only) and dataset size (0.5 T tokens).

| | Finetuning | | | | In-context Learning | | | |
|---|---|---|---|---|---|---|---|---|
| Model | SG | XS | SGD | TOT | SG | XS | SGD | TOT |
| GPT-like | 62.3 | 37.1/15.7/30.2 | 56.0 | 60.3 | 36.4 | 1.2/0.1/1.1 | 3.5 | 0.0 |
| T5 | 84.7 | 43.0/20.8/35.6 | 56.0 | 62.1 | 29.4 | 8.9/0.8/7.8 | 2.1 | 1.4 |
| UL2 | 83.3 | 43.3/21.0/35.9 | 56.5 | 62.6 | 45.4 | 15.4/2.5/11.1 | 9.6 | 7.8 |

The Present Example was also evaluated at a model size of about 20B parameters. The present experiments follow the same training protocol in earlier experiments by pretraining on the C4 corpus but by also scaling the number of tokens the model sees during pretraining. The present experiments use a batch size of 1024 and 512 TPUv4 chips for pretraining this model. The model is trained on a total of 1 trillion tokens on C4 (2 million steps). The sequence length is set to 512/512 for inputs and targets. Dropout is set to 0 during pretraining. The model has 32 encoder layers and 32 decoder layers, dmodel of 4096 and dff of 16384. The dimension of each head is 256 for a total of 16 heads. The model uses a model parallelism of 8. The results retain the same sentencepiece tokenizer as T5 of 32 k vocab size. Hence, UL20B can be interpreted as a model that is quite similar to T5 but trained with a different objective and slightly different scaling knobs. Similar to earlier experiments, UL20B is trained with Jax and T5X infrastructure.

To demonstrate the universality of the approach, the present experiments consider a total of nearly 50+ NLP tasks. The list and categorization of tasks is below. Note that the categorization of tasks are generally soft in nature and some tasks may cross into different categorization boundaries.

Language Generation—summarization and data-to-text generation tasks. CNN/Dailymail (Hermann et al., 2015), XSUM (Narayan et al., 2018), MultiNews (Fabbri et al., 2019), SAMSum (Gliwa et al., 2019), WebNLG (Castro Ferreira et al., 2020) (English), E2E (Dusek et al., 2019) and CommonGen (Lin et al., 2020) to evaluate our models. For WebNLG, E2E and CommonGen, use the versions from the GEM benchmark (Gehrmann et al., 2021).

Language Generation with Human Evaluation—evaluate on a variety of text generation tasks using human evaluation, via the GENIE leaderboard (Khashabi et al., 2021). These tasks include aNLG (Bhagavatula et al., 2019), ARC-DA (Clark et al., 2018), WMT19 (Foundation), and XSUM (Narayan et al., 2018).

Language Understanding, Classification and Question Answering—use Reading Comprehension, Question Answering, Text Classification and natural language inference datasets. Use RACE (Reading comprehension) (Lai et al., 2017), QASC (Khot et al., 2020), OpenBookQA (Mihaylov et al., 2018), TweetQA (Xiong et al., 2019), QuAIL (Rogers et al., 2020), IMDB (Maas et al., 2011), Agnews (Zhang et al., 2015), DocNLI (Yin et al., 2021), Adversarial NLI (Nie et al., 2019), VitaminC (Schuster et al., 2021a), Civil Comments and Wikipedia Toxicity detection datasets (Borkan et al., 2019). Use standard SuperGLUE (Wang et al., 2019) and GLUE (Wang et al., 2018) datasets.

Commonsense Reasoning—use HellaSwag (Zellers et al., 2019), SocialIQA/SIQA (Sap et al., 2019), PhysicalIQA/PIQA (Bisk et al., 2020), CosmosQA (Huang et al., 2019), AbductiveNLI (Bhagavatula et al., 2019), CommonsenseQA (Talmor et al., 2018), CommonsenseQA2 (Talmor et al., 2021).

Long Range Reasoning—Use the Scrolls benchmark (Shaham et al., 2022) which comprises of seven component tasks including GovReport (Huang et al., 2021), SumScr (Chen et al., 2021), QMSUm (Zhong et al., 2021), QASPER (Dasigi et al., 2021), NarrativeQA (Kocisk y et al., 2018), QuaLITY (Pang et al., 2021), and ContractNLI (Koreeda & Manning, 2021).

Structured Knowledge Grounding—use several component tasks from UnifiedSKG (Xie et al., 2022), namely WikiTQ (Pasupat & Liang, 2015), CompWQ (Talmor & Berant, 2018), FetaQA (Nan et al., 2021), HybridQA (Chen et al., 2020), WikiSQL (Zhong et al., 2017), TabFat (Chen et al., 2019), Feverous (Aly et al., 2021), SQA (Iyyer et al., 2017), MTOP (Li et al., 2020) and DART (Nan et al., 2020). Select datasets that are relatively convenient to perform evaluation and uses mainstream metrics such as accuracy or exact match instead of obscure ones or those that require significant domain specific post-processing.

Information Retrieval—IR is the task of retrieving relevant documents given queries. Use the setup of the latest next generation IR paradigm, i.e., differentiable search index (Tay et al., 2022) for the experiments. Use the same NQ (Kwiatkowski et al., 2019) splits in the DSI paper.

For each dataset, the best previous state of the art (SOTA) result is provided.

TABLE 2-7
Summary of UL20B results compared to state-of-the-art.

| Dataset | Metric | Eval | Sota Reference | SOTA | Ours |
|---|---|---|---|---|---|
| CNN/DM | Rouge-2 | Test | Zoph et al. | 21.7 | 21.9 |
| XSUM | Rouge-2 | Test | Zoph et al. | 27.1 | 26.6 |
| MultiNews | Rouge-2 | Test | Xiao et al. | 21.1 | 21.7 |
| SAMSum | Rouge-2 | Test | Narayan et al. | 28.3 | 29.6 |
| Gigaword | Rouge-2 | Test | Aghajanyan et al. | 20.7 | 20.7 |
| WebNLG (en) | Rouge-2 | Test | Bakshi et al. | 53.5 | 55.4 |
| E2E-NLG | Rouge-2 | Test | Xue et al. | 45.8 | 46.5 |
| CommonGen | Rouge-2 | Dev | Gehrmann et al. | 32.5 | 37.4 |
| Schema-Guided Dialog | Rouge-2 | Test | Gehrmann et al. | 36.8 | 44.1 |
| GENIE - aNLG | Human (H) | Test | Khashabi et al. | 76.0 | 77.0^{(l)} |
| GENIE - ARC-DA (w/o IR) | Human | Test | Khashabi et al. | 72.0 | 72.0^{(l)} |
| GENIE - WMT19 | Human | Test | Khashabi et al. | 71.0 | 67.0^{(l)} [symbol] |
| GENIE - XSUM | H-Overall | Test | Clive et al. | 51.0 | 50.0^{(l)} |
| GENIE - XSUM | H-Concise | Test | Clive et al. | 53.0 | 53.0^{(l)} |
| GENIE - XSUM | H-Fluency | Test | Clive et al. | 51.0 | 52.0^{(l)} |
| GENIE - XSUM | H-No-Hallucination | Test | Clive et al. | 53.0 | 54.0^{(l)} |
| GENIE - XSUM | H-Informativeness | Test | Clive et al. | 49.0 | 49.0^{(l)} |
| SIQA | Accuracy | Test | Lourie et al. | 83.2 | 83.3^{(l)} |
| PIQA | Accuracy | Test | Lourie et al. | 90.1 | 90.7^{(l)} |
| GSQA | Accuracy | Dev | Lourie et al. | 79.1 | 84.9 |
| CSQA2 | Accuracy | Test | Lourie et al. | 69.6^{(#)} | 70.1^{(l)} |
| QASC (w/o IR) | Accuracy | Dev | Khashabi et al. | 81.8 | 83.8 |
| QASC (w IR) | Accuracy | Test | Khashabi et al. | 89.6 | 90.7^{(l)} |
| TweetQA | BLEU-1 | Dev | Khashabi et al. | 77.5 | 78.4 |
| QuAIL | Accuracy | Test | Khashabi et al. | 74.2 | 87.2 |
| AdversarialQA (Bert) | F1 | Dev | Khashabi et al. | 53.6 | 70.1 |
| AdversarialQA (Roberta) | F1 | Dev | Khashabi et al. | 45.5 | 57.5 |
| AdversarialQA (Bidal) | F1 | Dev | Khashabi et al. | 71.5 | 77.5 |
| MCScript | Accuracy | Test | Khashabi et al. | 95.1 | 97.3 |
| MCScript 2.0 | Accuracy | Test | Khashabi et al. | 94.6 | 97.9 |
| RACE | Accuracy | Test | Shoeybi et al. | 90.9^{(e)} | 90.9 |
| DREAM | Accuracy | Test | Wan | 91.8 | 91.8 |
| OBQA | Accuracy | Test | Khashabi et al. | 87.2 | 87.2^{(l)} |
| CosmosQA | Accuracy | Test | Lourie et al. | 91.8 | 91.6^{(l)} |
| Winogrande XL | Accuracy | Test | Lourie et al. | 91.3 | 90.1^{(l)} |
| DocNLI | Accuracy | Test | Qin et al. | 76.9 | 88.2 |
| AdversarialNL [symbol] (r3) | Accuracy | Test | Wang et al. | 47.7 | 53.5 |
| VitaminC | Accuracy | Test | Schuster et al. | 90.8 | 91.1 |
| Hellaswag | Accuracy | Test | Lourie et al. | 93.9 | 94.1^{(l)} |
| QQP | F1 | Dev | Raffel et al. | 90.1 | 90.6 |
| QNLI | Accuracy | Dev | Raffel et al. | 96.1 | 96.5 |
| CoLA | Matthews | Dev | Raffel et al. | 68.6 | 71.5 |
| STSB | Spearman | Dev | Raffel et al. | 92.1 | 92.3 |
| AbductiveNLI | Accuracy | Test | He et al. | 89.8^{(#)} | 87.5^{(l)} |
| MultiNLI | Accuracy | Dev | Raffel et al. | 92.1 | 91.9 |
| IMDB | Accuracy | Test | Yang et al. | 96.2 | 97.3 |
| AgNews | Error | Test | Yang et al. | 4.45 | 4.42 |
| Civil Comments | F1 | Dev | Tay et al. | 87.8 | 87.9 |
| Wikipedia Toxicity | F1 | Dev | Tay et al. | 96.5 | 97.0 |
| SST-2 | Acc | Dev | Raffel et al. | 97.3 | 97.0 |
| Scrolls Challenge | Aggregate | Test | Shaham et al. | 29.2 | 37.9^{(l)} |
| SumScr | Rouge (Avg) | Test | Shaham et al. | 16.3 | 20.0^{(l)} |
| QMSum | Rouge (Avg) | Test | Shaham et al. | 19.9 | 20.0^{(l)} |
| QASPER | F1 | Test | Shaham et al. | 26.6 | 37.6^{(l)} |
| NarrativeQA | F1 | Test | Shaham et al. | 18.5 | 24.2^{(l)} |
| QUALITY | EM | Test | Shaham et al. | 26.0 | 45.8^{(l)} |
| ContractNLI | EM | Test | Shaham et al. | 77.4 | 88.7^{(l)} |
| GovRep | Rouge (Avg) | Test | Shaham et al. | 37.2 | 36.2^{(l)} |
| WikiTQ | Accuracy | Test | Xie et al. | 49.3 | 54.6 |
| CompWebQ | Accuracy | Test | Xie et al. | 73.3 | 75.9 |
| FetaQA | BLEU-4 | Test | Xie et al. | 33.4 | 35.8 |
| HybridQA | Accuracy | Dev | Eisenschlos et al. | 60.8 | 61.0 |
| WikiSQL | Accuracy | Test | Xie et al. | 86.0 | 87.3 |
| TabFat | Accuracy | Test | Xie et al. | 83.4 | 87.1 |
| Feverous | Accuracy | Dev | Xie et al. | 82.4 | 85.6 |
| SQA | Sent. Acc | Test | Xie et al. | 62.4 | 70.5 |
| MTOP | Match | Test | Xie et al. | 86.8 | 87.5 |
| DART | BLEU-4 | Test | Aghajanyan et al. | 47.2 | 50.4 |
| DSI-NQ | HITS@10 | Dev | Tay et al. | 70.3 | 73.8 |

^{(l)}denotes leaderboard submission.
^{(#)}denotes the best published found on the respective leaderboard.
^{(e)}denotes SOTA used an ensembled approach. [symbol]
indicates data missing or illegible when filed

UL2 achieves at least SOTA performance on around 50+ NLP tasks and setups. For many, the margins are quite wide and for those that UL2 doesn't achieve SOTA, the performance of UL2 is generally quite competitive. The extent of difficulty of obtaining SOTA on each benchmark has vastly different difficulties. For some, the SOTA model is a 32B dense equivalent (Zoph et al., 2022). For some others, it's a base model.

### Example Methods

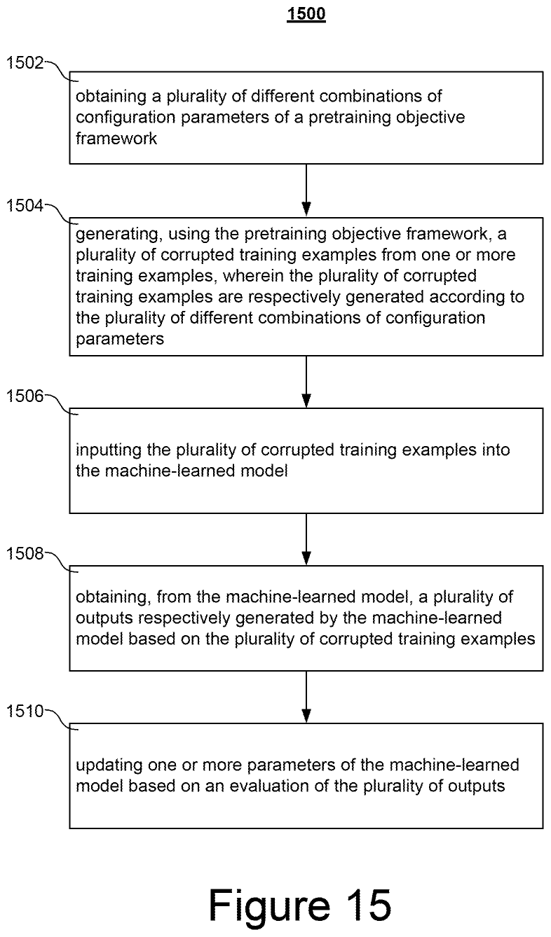

FIG. 15 depicts a flow chart diagram of an example method to perform according to example embodiments of the present disclosure. Although FIG. 15 depicts steps performed in a particular order for purposes of illustration and discussion, the methods of the present disclosure are not limited to the particularly illustrated order or arrangement. The various steps of the method 1500 can be omitted, rearranged, combined, and/or adapted in various ways without deviating from the scope of the present disclosure.

At 1502, example method 1500 can include obtaining a plurality of different combinations of configuration parameters of a pretraining objective framework. The pretraining objective framework (e.g., including pretraining pipeline 200) can include a parameterized corruption function that is configured to generate training examples according to one or more configuration parameters. For instance, the parameterized corruption function can be configured to receive original training examples (e.g., sequences of text, etc.) and output corrupted training examples. A plurality of different combinations of configuration parameters can respectively correspond to a plurality of objective configurations, such as objective configurations 206-212. A plurality of different combinations of configuration parameters can be obtained from a configuration file or other parameter storage.

At 1504, example method 1500 can include generating, using the pretraining objective framework, a plurality of corrupted training examples from one or more training examples. The plurality of corrupted training examples can be respectively generated according to the plurality of different combinations of configuration parameters. For instance, a different corrupted training example can be generated according to each of the plurality of different combinations of configuration parameters (e.g., according to each of a plurality of objective configurations).

At 1506, example method 1500 can include inputting the plurality of corrupted training examples into the machine-learned model. The machine-learned model can be configured to generate uncorrupted subportions corresponding to corrupted subportions of the corrupted training examples. For example, the machine-learned model can be configured to perform next-word generation based on surrounding context. The machine-learned model can be configured to leverage uncorrupted tokens bidirectionally as inputs for predicting the corrupted subportion.

At 1508, example method 1500 can include obtaining, from the machine-learned model, a plurality of outputs respectively generated by the machine-learned model based on the plurality of corrupted training examples.

At 1510, example method 1500 can include updating one or more parameters of the machine-learned model based on an evaluation of the plurality of outputs.

In some implementations of example method 1500, the configuration parameters can include two or more different parameters of: a subportion length parameter, a subportion quantity parameter, or a corruption rate parameter.

In some implementations of example method 1500, the plurality of different combinations of configuration parameters can include a distributed configuration configured for generating a plurality of corrupted subportions distributed over a training example and a sequential configuration configured for generating a corrupted subportion corresponding to a terminus of the training example.

In some implementations of example method 1500, the plurality of different combinations of configuration parameters can include a first distributed configuration configured for generating a first plurality of corrupted subportions distributed over a training example; a second distributed configuration configured for generating a second plurality of corrupted subportions distributed over the training example; and a sequential configuration configured for generating a corrupted subportion corresponding to a terminus of the training example. In some implementations of example method 1500, the second distributed configuration can be configured to cause greater corruption of the training example than the first distributed configuration

In some implementations of example method 1500, as compared to the first distributed configuration, the second distributed configuration can include at least one of: a subportion length parameter corresponding to a longer subportion length; or a corruption rate parameter corresponding to a greater rate of corruption.

In some implementations of example method 1500, the sequential configuration can correspond to a prefix-based language modeling objective.

In some implementations of example method 1500, the plurality of different combinations of configuration parameters can include: a first plurality of distributed configurations that can be respectively associated with subportion length parameters indicating subportion lengths of less than about 12 tokens; and a second plurality of distributed configurations that can be respectively associated with at least one of: subportion length parameters indicating subportion lengths of greater than about 12 tokens; or corruption rate parameters indicating a corruption rate of greater than about 30%. In some implementations of example method 1500, the plurality of different combinations of configuration parameters can include a sequential configuration. In some implementations of example method 1500, the plurality of different combinations of configuration parameters can include a quantity of one or more sequential configurations such that the quantity is less than about 50% of the total quantity of the plurality of configurations. In some implementations of example method 1500, the plurality of different combinations of configuration parameters can include a quantity of one or more sequential configurations such that the quantity is about 20% of the total quantity of the plurality of configurations.

In some implementations of example method 1500, the first plurality of distributed configurations can be respectively associated with subportion length parameters indicating subportion lengths of less than about 10 tokens.

In some implementations of example method 1500, the second plurality of distributed configurations can be respectively associated with subportion length parameters indicating subportion lengths of greater than about 12 tokens. In some implementations of example method 1500, the second plurality of distributed configurations can be respectively associated with subportion length parameters indicating subportion lengths of greater than about 30 tokens.

In some implementations of example method 1500, the second plurality of distributed configurations can be respectively associated with corruption rate parameters indicating a corruption rate of greater than about 30%. In some implementations of example method 1500, the second plurality of distributed configurations can be respectively associated with corruption rate parameters indicating a corruption rate of at least about 50%.

In some implementations of example method 1500, generating a plurality of corrupted training examples from the one or more training examples can include, for a respective training example of the one or more training examples (the respective training example including a respective sequence of data tokens), determining one or more selected subportions of the respective sequence of data tokens; and replacing the one or more selected subportions with a replacement token.

In some implementations of example method 1500, the example method 1500 can include inputting, with a respective corrupted training example of the plurality of corrupted training examples, a mode-switching token (e.g., modal token, such as “[R],” “[X],” “[S],” etc.) corresponding to at least one configuration of the plurality of different combinations of configuration parameters, the at least one configuration used to corrupt the respective corrupted training example.

In some implementations of example method 1500, the mode-switching token can trigger downstream behavior of the machine-learned model corresponding to tasks prioritized by the at least one configuration. For instance, the mode-switching token can be prepended to runtime inputs (e.g., at inference time) based on the type of task associated with the runtime input. For instance, short form generative tasks can use a mode-switching token associated with short form corrupted spans (e.g., “[R]”). Long form generative tasks can use a mode-switching token associated with long form corrupted spans (e.g., “[X]” or “[S]”).

In some implementations of example method 1500, at least one of the corruption parameters can be a probabilistic parameter. In some implementations of example method 1500, the probabilistic parameter can be the corrupted subportion length parameter characterizing a distribution from which a selected subportion length is sampled. In some implementations of example method 1500, the probabilistic parameter can be the corruption rate parameter characterizing a rate at which one or more selected subportions of a training example are corrupted.

In some implementations of example method 1500, the sequence of data tokens can correspond to natural language.

In some implementations of example method 1500, the sequence of data tokens can correspond to genetic data.

In some implementations of example method 1500, the sequence of data tokens can correspond to textual data.

In some implementations of example method 1500, the machine-learned model can include a transformer encoder. In some implementations of example method 1500, the machine-learned model can include a transformer decoder.

In some implementations of example method 1500, the example method 1500 can include generating a first fine-tuned version of the machine-learned model for a first task; and generating a second fine-tuned version of the machine-learned model for a second, different task.

In some implementations of example method 1500, the first task can be at least one of a classification task or a sequence-to-sequence task. In some implementations of example method 1500, the second, different task can be at least one of an open-text generation or prompt-based inference task.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Also, terms such as “based on” should be understood as “based at least in part on.”

What is claimed is:

1. A computer-implemented method for improved prompting of a machine-learned model, the method comprising:
obtaining, by a computing system comprising one or more processors, an instructive sequence descriptive of an instructive query, an instructive response, and an instructive trace of intermediate states from the instructive query to the instructive response;
inputting, by the computing system and to the machine-learned model, the instructive sequence and an operative query, wherein the machine-learned model has been pre-trained using a plurality of diversified objectives; and
generating, by the computing system, using the machine-learned model and responsive to the operative query, an operative response.

2. The computer-implemented method of claim 1, wherein the machine-learned model is configured to process the operative query with attention over the instructive sequence to generate an operative trace of intermediate states from the operative query to the operative response.

3. The computer-implemented method of claim 1, wherein:
the instructive sequence is prepended to the operative query; and
the instructive trace comprises a chain of intermediate responses to intermediate queries.

4. The computer-implemented method of claim 1, wherein the instructive sequence comprises a tokenized representation of a natural language.

5. The computer-implemented method of claim 1, wherein generating the operative response comprises:
generating, by the computing system and using the machine-learned model, a plurality of operative responses; and
determining, by the computing system, the operative response based on a sample of the plurality of operative responses.

6. The computer-implemented method of claim 1, wherein the operative query is a first query component and the operative response is a first response component, and wherein the method comprises:
inputting, by the computing system and to the machine-learned model, the instructive sequence, the first query component, the first response component, and a second query component; and
generating, by the computing system, using the machine-learned model and responsive to the second query component, a second response component.

7. The computer-implemented method of claim 1, wherein to pre-train the machine-learned model using the plurality of diversified objectives the machine-learned model has been pre-trained using a plurality of different combinations of configuration parameters of a pretraining objective framework.

8. The computer-implemented method of claim 7, wherein the machine-learned model has been pre-trained on a plurality of corrupted training examples that were generated from one or more training examples, wherein the plurality of corrupted training examples were respectively generated according to the plurality of different combinations of configuration parameters.

9. The computer-implemented method of claim 8, wherein the pre-training objectives required to machine-learned model to generate uncorrupted subportions corresponding to corrupted subportions of the corrupted training examples.

10. The computer-implemented method of claim 7, wherein the configuration parameters comprise two or more different parameters of: a subportion length parameter, a subportion quantity parameter, or a corruption rate parameter.

11. The computer-implemented method of claim 7, wherein the plurality of different combinations of configuration parameters comprise:
a distributed configuration configured for generating a plurality of corrupted subportions distributed over a training example; and
a sequential configuration configured for generating a corrupted subportion corresponding to a terminus of the training example.

12. The computer-implemented method of claim 7, wherein the plurality of different combinations of configuration parameters comprise:
a first distributed configuration configured for generating a first plurality of corrupted subportions distributed over a training example;
a second distributed configuration configured for generating a second plurality of corrupted subportions distributed over the training example, wherein the second distributed configuration is configured to cause greater corruption of the training example than the first distributed configuration; and
a sequential configuration configured for generating a corrupted subportion corresponding to a terminus of the training example.

13. The computer-implemented method of claim 1, wherein at least one of the plurality of diversified objectives comprises a bidirectional masked language modeling objective.

14. One or more memory devices storing non-transitory computer-readable instructions for improved prompting of a machine-learned model, the instructions executable to cause one or more processors to perform operations, the operations comprising:
obtaining an instructive sequence descriptive of an instructive query, an instructive response, and an instructive trace of intermediate states from the instructive query to the instructive response;
inputting, to a machine-learned model, the instructive sequence and an operative query, wherein the machine-learned model is configured to process the operative query with attention over the instructive sequence, and wherein the machine-learned model has been pre-trained using a plurality of diversified objectives; and
generating using the machine-learned model and responsive to the operative query, an operative response.

15. The one or more memory devices of claim 14, wherein the machine-learned model is configured to process the operative query with attention over the instructive sequence to generate an operative trace of intermediate states from the operative query to the operative response.

16. The one or more memory devices of claim 14, wherein:
the instructive sequence is prepended to the operative query; and
the instructive trace comprises a chain of intermediate responses to intermediate queries.

17. The one or more memory devices of claim 14, wherein to pre-train the machine-learned model using the plurality of diversified objectives the machine-learned model has been pre-trained using a plurality of different combinations of configuration parameters of a pretraining objective framework.

18. The one or more memory devices of claim 17, wherein the machine-learned model has been pre-trained on a plurality of corrupted training examples that were generated from one or more training examples, wherein the plurality of corrupted training examples were respectively generated according to the plurality of different combinations of configuration parameters.

19. The one or more memory devices of claim 14, wherein at least one of the plurality of diversified objectives comprises a bidirectional masked language modeling objective.

20. A computing system for improved prompting of a machine-learned model, the system comprising:
one or more processors; and
one or more memory devices storing non-transitory computer-readable instructions that are executable to cause the one or more processors to perform operations, the operations comprising:
obtaining a chain of thought prompt comprising an instructive trace through a series of intermediate states;
inputting, to a machine-learned model, the chain of thought prompt, wherein the machine-learned model has been pre-trained using a plurality of diversified objectives; and
generating using the machine-learned model and responsive to the chain of thought prompt, an operative response.
